(19) United States
(12) Patent Application Publication
(10) Pub. No.: US 2025/0392422 A1
(43) Pub. Date: Dec. 25, 2025

(54) MODIFICATION OF PERIODIC MULTI-SLOT ALLOCATIONS

(71) Applicant: Telefonaktiebolaget LM Ericsson (publ), Stockholm (SE)

(72) Inventors: Jonas FRÖBERG OLSSON, Ljungsbro (SE); Bikramjit SINGH, Kirkkonummi (FI); Yufei BLANKENSHIP, Kildeer, IL (US); Ying SUN, Täby (SE)

(21) Appl. No.: 18/879,357

(22) PCT Filed: Jun. 30, 2023
(86) PCT No.: PCT/EP2023/068089

§ 371 Date: Dec. 27, 2024

Related U.S. Application Data
(60) Provisional application No. 63/357,760, filed on Jul. 1, 2022.

(51) Int. Cl. H04L 5/00; H04W 72/21

(52) U.S. Cl. CPC H04L 5/0048; H04W 72/21

(57) ABSTRACT

A method performed by a first network node in a communication system is provided. The method includes transmitting an indicator including one of a first indicator including an indication that one or more resources is unutilized in a periodic multi-slot allocation for a second network node within a period, or a second indicator including an indication of a shortage of one or more resources in the periodic multi-slot allocation for the second network node within the period. The method further includes performing one of responsive to transmitting or receiving the first indicator, reducing the periodic multi-slot allocation by at least part of the unutilized one or more resources for at least a period, or adding at least one resource to at least a period. A method performed by a second network node, and related methods and apparatus are also provided.

### TECHNICAL FIELD

The present disclosure relates generally to methods performed by a network node for modification of periodic multi-slot allocations, and related methods and apparatuses.

### BACKGROUND

Next generation mobile wireless communication systems (e.g., fifth generation (5G) or new radio (NR)), will support a diverse set of use cases and a diverse set of deployment scenarios. For example, deployment scenarios may include deployment at both low frequencies (e.g., 100s of MHz), similar to present long term evolution (LTE), and very high frequencies (e.g., mm waves in the tens of GHz).

Similar to LTE, NR will use Orthogonal Frequency Division Multiplexing (OFDM) in the downlink (e.g., from a network node, such as a gNodeB (gNB), evolved nodeB (eNB), or base station, to a user equipment (UE)). In the uplink (e.g., from UE to gNB), both OFDM and direct Fourier transform-spread OFDM (DFT-S-OFDM), also known as single-carrier frequency division multiple access (SC-FDMA) in LTE, will be supported. FIG. 1 is schematic diagram illustrating NR physical resources. As illustrated in FIG. 1, a basic NR physical resource can be seen as a time-frequency grid, where a resource block (RB) in a 14-symbol slot is shown. As shown in FIG. 1, a resource block corresponds to 12 contiguous subcarriers in the frequency domain. Resource blocks may be numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (which also may be referred to as different numerologies) may be given by Δf=(15×2^{μ}) kHz where μ is a non-negative integer and can be one of {0, 1, 2, 3, 4}. Δf=15 kHz (e.g., μ=0) is the basic (or reference) subcarrier spacing that is also used in LTE. μ is also referred to as the numerology.

In the time domain, downlink and uplink transmissions in NR may be organized into equally-sized subframes of 1 ms each (e.g., similar to LTE). A subframe may be further divided into multiple slots of equal duration. The slot length is dependent on the subcarrier spacing or numerology and may be given by

$$\frac{1}{{2}^{μ}}$$

ms. Each slot includes 14 OFDM symbols for normal Cyclic Prefix (CP).

It is noted that data scheduling in NR may be in slot basis. FIG. 2 is a schematic diagram illustrating an example NR time-domain structure with 15 kHz subcarrier spacing. In the example of FIG. 2, a 14-symbol slot is included, where the first two symbols contain control channel (as illustrated, physical downlink control channel (PDCCH)) and the remainder contains data channel (as illustrated, physical downlink shared channel (PDSCH)).

Downlink transmissions can be dynamically scheduled, e.g., in each slot a gNB transmits downlink control information (DCI) about which UE data is to be transmitted to and which resource blocks in the current downlink slot the data is transmitted on. This control signaling typically may be transmitted in the first one or two OFDM symbols in each slot in NR. The control information may be carried on a PDCCH and data may be carried on a PDSCH. A UE may first detect and decode a PDCCH and if the PDCCH is decoded successfully, the UE may decode a corresponding PDSCH based on decoded control information in the PDCCH.

Uplink data transmission can also be dynamically scheduled using PDCCH. Similar to downlink, a UE may first decode uplink grants in a PDCCH and then transmit data over a physical uplink shared channel (PUSCH) based on decoded control information in the uplink grant, such as modulation order, coding rate, uplink resource allocation, etc.

Multi-PUSCH transmissions were introduced in new radio unlicensed (NR-U) to be able to indicate to a UE a set of multiple occasions for PUSCH that the UE may use if the UE senses the channel to be free to use. For signaling the number of scheduled PUSCHs and time domain resource allocation (TDRA) in one DCI format 0_1 scheduling multiple PUSCHs, a TDRA table may be extended such that each row indicates multiple PUSCHs that are contiguous in time-domain. Each PUSCH may have has a separate Start and Length Indicator Value (SLIV) and mapping type, however, each PUSCH may have the same frequency resource allocation. The number of scheduled PUSCHs may be signalled by the number of indicated valid SLIVs in a row of the TDRA table signalled in DCI. A maximum number of PUSCHs that can be scheduled by a single DCI is 8. In NR Rel-16, multi-PUSCH transmissions is also supported for licensed spectrum. Moreover, in NR Rel-17, functionality enabling multi-PDSCH for high sub-carrier spacing is under development in the third generation partnership project (3GPP). This multi-PDSCH functionality potentially may be extended to low subcarrier spacings (SCSs). For example, 3GPP agreements made in RAN1 #105e include: Do not use fallback DCI (i.e., DCI formats 0_0 and 1_0) for multi-PDSCH/PUSCH scheduling; Use DCI format 0_1 to schedule multiple PUSCHs with a single DCI; and Use DCI format 1_1 to schedule multiple PDSCHs with a single DCI.

Configured grant (CG) uplink control information (UCI) may be included in every NR-U CG-PUSCH transmission. The CG-UCI may include the information in the following table:

UCI content

Hybrid automatic repeat request (HARQ)
Redundancy version (RV)
New data indicator (NDI)
Channel occupancy time (COT) sharing information
Cyclic redundancy check (CRC)

CG-UCI may be mapped as per Rel-15 rules for (UCI) multiplexing on PUSCH with CG-UCI having the highest priority. CG-UCI may be mapped on the symbols starting after a first demodulation reference symbol (DMRS). To determine a number of resource elements (REs) used for CG-UCI, the mechanism of beta-offset in Rel-15 NR for HARQ-ACK on CG-PUSCH may be reused. Nonetheless, a new radio resource control (RRC) configured beta-offset for CG-UCI may be defined.

If CG-PUSCH resources overlap with PUCCH carrying channel state information (CSI) CSI-part1 and/or CSI-part 2, the later can be sent on CG-PUSCH. A RRC configuration can be provided to the UE indicating whether to multiplex CG-UCI and HARQ-ACK. If configured, in the case of PUCCH overlapping with CG-PUSCH(s) within a PUCCH group, the CG-UCI and HARQ-ACK may be jointly encoded as one UCI type. Otherwise, configured grant PUSCH may be skipped if CG-PUSCH overlaps with PUCCH that carries HARQ ACK feedback.

Extended reality (XR) is an emerging use case to be addressed in the evolution of 5G NR. A definition of XR is included in 3GPP SA4 TR 26.928, February 2019. XR may include real-and-virtual combined environments and human-machine interactions. An aspect of XR relates to the senses of existence (represented by virtual reality (VR)) and the acquisition of cognition (represented by augmented reality (AR)). Table 7.6.1-1 in 3GPP TS 22.261 V18.6.1 provides an example of a key performance indicator (KPI) table for high data rate and low latency service for an XR type of traffic. XR may be characterized by non-deterministic packet size(s) and even though traffic is periodic, time of arrival may vary quite a bit which may be challenging for a scheduler to allocate resources (e.g., in a fast and efficient manner).

### SUMMARY

There currently exist certain challenges. A method to modify periodic multi-slot allocations may be lacking. For example, when data packet sizes vary per period, data may not be available or may not have arrived. As a consequence, if a periodic multi-slot allocation contains pre-configured resources, but the data falls short, there may be a risk that the pre-configured resources are wasted within the period.

Certain aspects of the disclosure and their embodiments may provide solutions to these or other challenges.

In various embodiments of the present disclosure, a method performed by first network node in a communication system is provided. The method includes transmitting an indicator including one of (i) a first indicator including an indication that one or more resources is unutilized in a periodic multi-slot allocation for a second network node within a period, or (ii) a second indicator including an indication of a shortage of one or more resources in the periodic multi-slot allocation for the second network node within the period. The method further includes performing one of (i) responsive to transmitting or receiving the first indicator, reducing the periodic multi-slot allocation by at least a part of the unutilized one or more resources for at least a period, or (ii) responsive to transmitting or receiving the second indicator, adding at least one resource to at least a period.

In other embodiments, a method performed by a second network node in a communication system is provided. The method includes receiving an indicator from a first network node including one of (i) a first indicator including an indication that one or more resources is unutilized in a periodic multi-slot allocation for the second network node within a period, or (ii) a second indicator including an indication of a shortage of one or more resources in the periodic multi-slot allocation for the second network node within the period. The method further includes, responsive to receiving the first indicator, omitting to monitor or decode a transmission from the first network node over the one or more unutilized resources in the period.

In other embodiments, a first network node is provided. The first network node includes processing circuitry; and at least one memory coupled with the processing circuitry. The memory includes instructions that when executed by the processing circuitry causes the first network node to perform operations. The operations include to transmit an indicator including one of (i) a first indicator including an indication that one or more resources is unutilized in a periodic multi-slot allocation for a second network node within a period, or (ii) a second indicator including an indication of a shortage of one or more resources in the periodic multi-slot allocation for the second network node within the period. The operations further include to perform one of (i) responsive to transmission or receipt of the first indicator, reduce the periodic multi-slot allocation by at least part of the unutilized one or more resources for at least a period, or (ii) responsive to transmission or receipt of the second indicator, add at least one resource to at least a period.

In other embodiments, a first network node is provided that is adapted to perform operations. The operations include to transmit an indicator including one of (i) a first indicator including an indication that one or more resources is unutilized in a periodic multi-slot allocation for a second network node within a period, or (ii) a second indicator including an indication of a shortage of one or more resources in the periodic multi-slot allocation for the second network node within the period. The operations further include to perform one of (i) responsive to transmission or receipt of the first indicator, reduce the periodic multi-slot allocation by at least part of the unutilized one or more resources for at least a period, or (ii) responsive to transmission or receipt of the second indicator, add at least one resource to at least a period.

In other embodiments, a computer program comprising program code is provided to be executed by processing circuitry of a first network node. Execution of the program code causes the first network node to perform operations. The operations include to transmit an indicator including one of (i) a first indicator including an indication that one or more resources is unutilized in a periodic multi-slot allocation for a second network node within a period, or (ii) a second indicator including an indication of a shortage of one or more resources in the periodic multi-slot allocation for the second network node within the period. The operations further include to perform one of (i) responsive to transmission or receipt of the first indicator, reduce the periodic multi-slot allocation by at least part of the unutilized one or more resources for at least a period, or (ii) responsive to transmission of the second indicator, add at least one resource to at least a period.

In other embodiments, a computer program product is provided comprising a non-transitory storage medium including program code to be executed by processing circuitry of a first network node. Execution of the program code causes the first network node to perform operations. The operations include to transmit an indicator including one of (i) a first indicator including an indication that one or more resources is unutilized in a periodic multi-slot allocation for a second network node within a period, or (ii) a second indicator including an indication of a shortage of one or more resources in the periodic multi-slot allocation for the second network node within the period. The operations further include to perform one of (i) responsive to transmission or receipt of the first indicator, reduce the periodic multi-slot allocation by at least part of the unutilized one or more resources for at least a period, or (ii) responsive to transmission or receipt of the second indicator, add at least one resource to at least a period.

In yet other embodiments, a second network node is provided. The second network node includes processing circuitry; and at least one memory coupled with the processing circuitry. The memory includes instructions that when executed by the processing circuitry causes the second network node to perform operations. The operations include to receive an indicator from a first network node including one of (i) a first indicator including an indication that one or more resources is unutilized in a periodic multi-slot allocation for the second network node within a period, or (ii) a second indicator including an indication of a shortage of one or more resources in the periodic multi-slot allocation for the second network node within the period. The operations further include, responsive to receiving the first indicator, to omit to monitor or decode a transmission from the first network node over the one or more unutilized resources in the period.

In other embodiments, a second network node is provided that is adapted to perform operations. The operations include to receive an indicator from a first network node including one of (i) a first indicator including an indication that one or more resources is unutilized in a periodic multi-slot allocation for the second network node within a period, or (ii) a second indicator including an indication of a shortage of one or more resources in the periodic multi-slot allocation for the second network node within the period. The operations further include, responsive to receiving the first indicator, to omit to monitor or decode a transmission from the first network node over the one or more unutilized resources in the period.

In other embodiments, a computer program comprising program code is provided to be executed by processing circuitry of a second network node. Execution of the program code causes the second network node to perform operations. The operations include to receive an indicator from a first network node including one of (i) a first indicator including an indication that one or more resources is unutilized in a periodic multi-slot allocation for the second network node within a period, or (ii) a second indicator including an indication of a shortage of one or more resources in the periodic multi-slot allocation for the second network node within the period. The operations further include, responsive to receiving the first indicator, to omit to monitor or decode a transmission from the first network node over the one or more unutilized resources in the period.

In other embodiments, a computer program product is provided comprising a non-transitory storage medium including program code to be executed by processing circuitry of a second network node. Execution of the program code causes the second network node to perform operations. The operations include to receive an indicator from a first network node including one of (i) a first indicator including an indication that one or more resources is unutilized in a periodic multi-slot allocation for the second network node within a period, or (ii) a second indicator including an indication of a shortage of one or more resources in the periodic multi-slot allocation for the second network node within the period. The operations further include, responsive to receiving the first indicator, to omit to monitor or decode a transmission from the first network node over the one or more unutilized resources in the period.

In some embodiments, a method performed by a first network node in a communication system is provided. The method includes transmitting an indicator including one of (i) a first indicator including an indication that shows which of one or more resources is unutilized in a configured periodic resource allocation, or (ii) a second indicator including an indication of a shortage of one or more resources in the configured periodic resource allocation. The method further includes performing one of (i) based on transmitting the first indicator, not transmitting on the unutilized resources, or (ii) based on transmitting the second indicator, adding at least one resource.

In other embodiments, a first network node is provided. The first network node includes processing circuitry; and memory coupled with the processing circuitry. The memory includes instructions that when executed by the processing circuitry causes the first network node to perform operations. The operations include to transmit an indicator including one of (i) a first indicator including an indication that shows which of one or more resources is unutilized in a configured periodic resource allocation, or (ii) a second indicator including an indication of a shortage of one or more resources in the configured periodic resource allocation. The operations further include to perform one of (i) based on transmitting the first indicator, not transmitting on the unutilized resources, or (ii) based on transmitting the second indicator, adding at least one resource.

In some embodiments, a first network node is provided that is adapted to perform operations. The operations include to transmit an indicator including one of (i) a first indicator including an indication that shows which of one or more resources is unutilized in a configured periodic resource allocation, or (ii) a second indicator including an indication of a shortage of one or more resources in the configured periodic resource allocation. The operations further include to perform one of (i) based on transmitting the first indicator, not transmitting on the unutilized resources, or (ii) based on transmitting the second indicator, adding at least one resource.

In yet other embodiments, a computer program is provided comprising program code to be executed by processing circuitry of a first network node. Execution of the program code causes the first network node to perform operations. The operations include to transmit an indicator including one of (i) a first indicator including an indication that shows which of one or more resources is unutilized in a configured periodic resource allocation, or (ii) a second indicator including an indication of a shortage of one or more resources in the configured periodic resource allocation. The operations further include to perform one of (i) based on transmitting the first indicator, not transmitting on the unutilized resources, or (ii) based on transmitting the second indicator, adding at least one resource.

In other embodiments, a computer program product is provided comprising a non-transitory storage medium including program code to be executed by processing circuitry of a first network node. Execution of the program code causes the first network node to perform operations. The operations include to transmit an indicator including one of (i) a first indicator including an indication that shows which of one or more resources is unutilized in a configured periodic resource allocation, or (ii) a second indicator including an indication of a shortage of one or more resources in the configured periodic resource allocation. The operations further include to perform one of (i) based on transmitting the first indicator, not transmitting on the unutilized resources, or (ii) based on transmitting the second indicator, adding at least one resource.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating NR physical resources;

FIG. 2 is a schematic diagram illustrating an example NR time-domain structure with 15 kHz subcarrier spacing;

FIG. 3 is a schematic diagram illustrating an example embodiment of reduction of multi-slot allocation in one period in accordance with the present disclosure;

FIG. 4 is a schematic diagram illustrating an example embodiment of a reduction of multi-slot allocation size in two consecutive periods in accordance with the present disclosure;

FIG. 5 is a schematic diagram illustrating an example embodiment of a reduction of multi-slot allocation size in a sequence of consecutive periods in accordance with the present disclosure;

FIG. 6 is a schematic diagram illustrating an example embodiment of a minimum time for a UE to free up a resource so that it can be usable to another UE periods in accordance with the present disclosure;

FIG. 7 is a schematic diagram illustrating an example embodiment of addition transport blocks (TBs) in one period of a multi-slot allocation in accordance with the present disclosure;

FIG. 8 is a schematic diagram illustrating an example embodiment of addition TBs in two consecutive periods of a multi-slot allocation in accordance with the present disclosure;

FIG. 9 is a schematic diagram illustrating an example embodiment of addition of TBs in a sequence of consecutive periods of a multi-slot allocation in accordance with the present disclosure;

FIG. 10 is a schematic diagram illustrating an example embodiment of changing of a multi-slot allocation size in a sequence of consecutive periods in accordance with the present disclosure;

FIG. 11 is a flow chart of operations of a first network node in accordance with some embodiments of the present disclosure;

FIG. 12 is a flow chart of operations of a second network node in accordance with some embodiments of the present disclosure;

FIG. 13 is a block diagram of a communication system in accordance with some embodiments;

FIG. 14 is a block diagram of a user equipment (UE) in accordance with some embodiments;

FIG. 15 is a block diagram of a network node in accordance with some embodiments;

FIG. 16 is a block diagram of a host computer communicating with a UE in accordance with some embodiments;

FIG. 17 is a block diagram of a virtualization environment in accordance with some embodiments; and

FIG. 18 is a block diagram of a host computer communicating via a base station with a UE over a partially wireless connection in accordance with some embodiments in accordance with some embodiments.

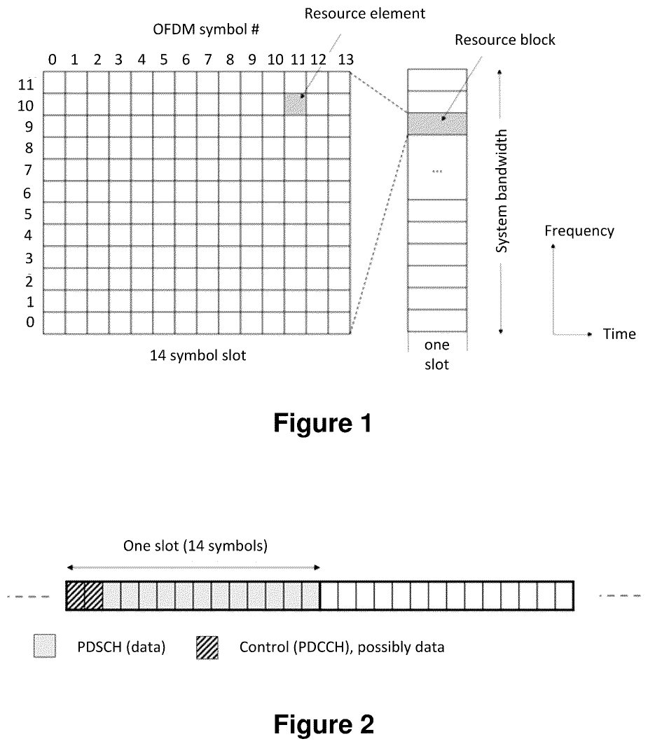

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Emerging use cases, such as XR, may include uplink (UL)/downlink (DL) data packets that arrive periodically, and the packets can be large. For large periodic packets, periodic multi-slot scheduling (e.g., multi-PUSCH CG and/or multi-PDSCH SPS) may be an option to allocate large data packets. As used herein, “multi-slot CG/SPS” refers to a method of periodic allocation, where within a period for a given CG ID or SPS, the period contains multi-slot allocations (e.g., to transmit multiple transport blocks (TBs) or hybrid automatic repeat request (HARQ) processes), which may help to transmit large amounts of data in a period of CG/SPS.

3GPP discussions for Release 18 include proposed objectives on XR-specific capacity considerations (e.g., RP-213052, December 2021); and proposed enhancement of CG/semi-persistent scheduling (SPS) for XR data transmissions (e.g., meeting 109e, May 2022).

While there has been discussion in 3GPP to support multi-slot CG/SPS for an XR traffic type, there currently exist certain challenges. For example, as a consequence of packet size variance per period, at times, data may not be available or may not have arrived. This may be a problem when a period (e.g., a CG/SPS period) contains large pre-configured resources, but the data falls short, such that there is a risk that allocations of resources within the period may be wasted. Thus, there may be a need for multi-slot allocation (e.g., multi-slot CG/SPS) for data (e.g., for heavy/large packet transmission such as for XR, video packet transmission, etc.) that includes a policy/policies to deter resource wastage.

Certain aspects of the present disclosure and their embodiments may provide solutions to these or other challenges. Some embodiments include a periodic multi-slot allocation to a first network node (e.g., a UE) where multiple transmissions/allocations are allocated per period using a single DCI/RRC signaling (e.g. a single DCI/RRD allocating periodic multi-slot allocation). For example, NR/NR-U CG/SPS activation signaling that is DCI or RRC based allocating multi-PUSCH, multi-PDSCH, and/or TB over multiple slots (TBoMs) per CG/SPS period. The RRC or DCI activation may be, e.g., Type 1 or 2 CG activation or SPS activation. In some embodiments, multiple CGs/SPSs allocated by separate by DCIs/RRCs may be organized into multi-allocation mimicking a multi-slot allocation.

Given that the network has allocated periodic multi-slot allocation to the first network node using RRC or DCI activation (e.g., Type 1 or 2 CG activation or SPS activation), in some embodiments, if a first network node (e.g., a UE in case of CG, or a gNB in case of SPS) has no more data to transmit in a period (e.g., after utilizing some multi-slot occasions in a period), the first network node transmits an indicator. The indicator may be an explicit indicator or non-explicit indicator (e.g., having policies in place to derive the indicator at the second network node receiving the indicator). Further, the indicator may be a first indicator that indicates one or more multi-slot occasions (that is, resources) in a periodic multi-slot allocation within the period does not have data or transmissions, or the indicator may be a second indicator that indicates a shortage of one or more resources in the periodic multi-slot allocation for a period.

Based on the indication received (explicitly or derived (implicitly), and first indicator or second indicator), the network node receiving the first indicator may not monitor the transmissions over the set of resources (that is, over the multi-slot allocation) within the period. Further, in some embodiments, responsive actions may be performed by the same network node that transmits the indicator (e.g., the same network node that transmits the indicator that there is lack of utilization/shortage of resources). The receiver network node (e.g., a gNB/eNB) may change the allocation of resources. For example, if the first network node receives the second indicator, the first network node may add more occasions (e.g., autonomously).

In some embodiments, the first network node is free to schedule the unutilized resources from the given periodic multi-slot allocation in a period.

Further, in some embodiments, the event in a period does not impact the next period. For example, if a first network node transmits the indication related to resource use for a given period, then in a next or consecutive period, the first network node has a default right to use the resource in the period wholly or to send the indication indicating partial or no usage of resource, which is independent of previous period.

As used herein, the term “multi-slot allocation in a period” refers to a scheduled resource allocation that can span over multiple scheduling time units (e.g., N time units, where N is an integer and N>1). The time unit can be a slot (in other words, a multi-slot allocation); a mini-slot (in other words, multi-mini-slot allocation); and/or a set of N consecutive symbols, etc. Scheduling, however, is not limited to being purely slot-based. For example, a CG period of three slots can have resources allocated for three TBs within a period spanned over 1.5 slots (e.g., symbol 0 to symbol 5 for TB1, symbol 6 to symbol 13 for TB2, and symbol 0 to symbol 6 in the next slot for TB3 (in other words, e.g., a type of multi-slot allocation with three TBs or HARQ processes in each period).

The term “multi-slot allocation” herein may be interchangeable and replaced with the terms “multi-transport block” (or “multi-TB”), “multi-HARQ”, “multi-transmission”, and/or “multi-PxSCH transmissions”, where “x” indicates “D” or “U”.

While embodiments herein are explained in the non-limiting context of a first network node that includes a transmitter and a second network node that includes a receiver to indicate uplink (UL) and downlink (DL) signaling in a communication system, the invention is not so limited. Instead, the method includes other signaling technologies including, without limitation, device-to-device (D2D), sidelink (SL), IAB, Wi-Fi, etc., where the first network node includes a transmitter and the second network node includes a receiver. Thus, the first network node may be, without limitation, a gNB, an eNB, a base station, or a UE, respectively. When the first network node is one of gNB, and eNB, or a base station, for example, the second network node may be, without limitation, a UE. In other embodiments, when the first network node is a UE, the second network node may be, without limitation, another UE. Further, in some embodiments, the first network node may be a UE in the case of CG, or a gNB or eNB in the case of SPS.

As previously discussed, the indicator can indicate that a subset of allocation from a multi-slot allocation within a period remains unutilized (in other words, the transmitter has refrained from transmitting data on this subset). For ease of discussion only, in some embodiments the indicator is referred to as a limited data indicator (LDI).

On the other hand, as previously discussed, if there is a shortage (e.g., a few occasions or a small subset of resources pertaining to multi-slot allocations) of active or allocated resources in a periodic allocation (e.g., in a period), the first network node (e.g., a gNB) can add or activate more occasions for a given multi-slot allocation in a period (e.g., in a given CG/SPS in a period) based on the increased need for resource consumption by a transmitter (e.g., of a UE, a gNB, etc.). In an example embodiment for a CG case, a second network node (e.g., a UE) can also indicate to the first network node (e.g., a gNB) using a buffer status report (BSR)/UCI/scheduling request (SR) regarding a need for more data transmission. In another example embodiment, the first network node (e.g., a gNB) can check a history including statistics of grants/assignment distributions and can allocate more resources per CG/SPS.

As a consequence of transmitting the indicator, in some embodiments, the network node receiving the indicator does not try to decode or monitor the transmissions over unutilized resource in the period (that is, resources which are referenced by the indicator); and/or in some embodiments, the first network node is free to allocate, e.g., schedule the unutilized resource(s) within a period to the same or other network nodes (e.g., UEs) for other purposes.

While embodiments herein are explained in the non-limiting context of the indicator indicating which resources are unutilized in a period, the invention is not so limited. Instead, the indicator included in the method of the present disclosure may be used to indicate which resources are used in a period. Additionally, in some embodiments, the network node transmitting or receiving the indicator may automatically derive the unutilized resources from a period.

Without limitation, embodiments of the present disclosure may be applied to licensed, shared, NR-U, NR, TDD, and/or FDD types of spectrum.

Certain embodiments may provide one or more of the following technical advantages. Based on inclusion of the first indicator (e.g., a LDI), the first indicator may be used to free up unnecessarily allocated resources to decrease network interference or to reallocate unused resources and increase system capacity. On the other hand, if the usage requirement goes up for a network node (e.g., UE/gNB), the network node transmitting or receiving the indicator can allocate more resources (e.g., TBs/slots) for a given periodic multi-slot allocation (e.g., for a given CG/SPS). For example, for a given CG/SPS, inclusion of the indicator may keep a CG/SPS configuration tailored to transmitter needs. As a consequence, this may be efficient because the first network node (e.g., a gNB) will not need to allocate separate CGs/SPSs which typically require separate treatment and, thus, may be less efficient than a single CG/SPS with flexible TB resources. Thus, such a CG/SPS enhancement using multi-slot allocation may make it simple/easier to deal with periodic heavy traffic rather than using multiple different CG/SPS configurations.

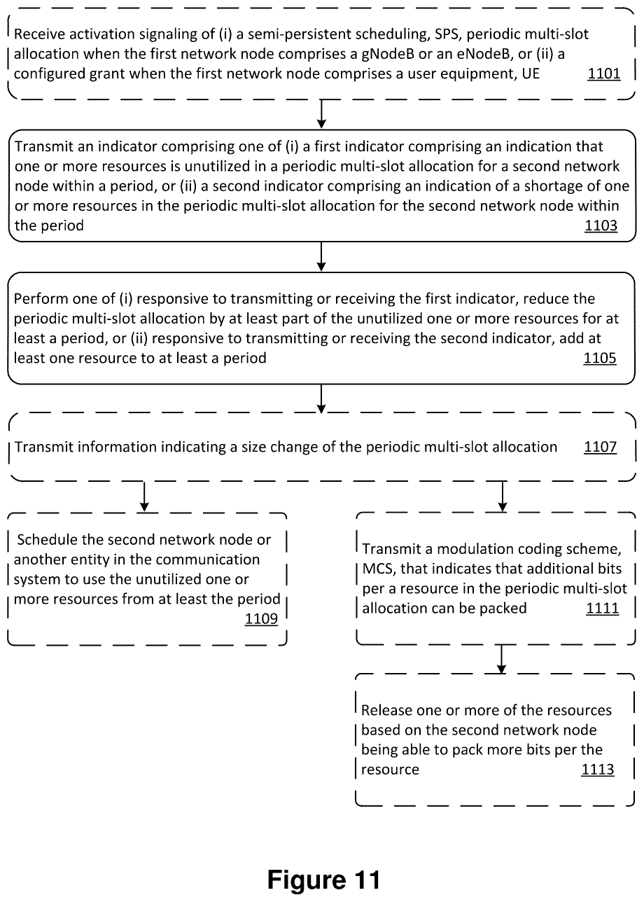

FIG. 11 is a flow chart illustrating operations of a method performed by a first network node (e.g., first network node 13110/15300, 13112/14200, 13112A discussed herein) in a communication system. The method includes transmitting (1103) an indicator including one of (i) a first indicator including an indication that one or more resources is unutilized in a periodic multi-slot allocation for a second network node within a period, or (ii) a second indicator including an indication of a shortage of one or more resources in the periodic multi-slot allocation for the second network node within the period. The method further includes performing (1105) one of (i) responsive to transmitting or receiving the first indicator, reducing the periodic multi-slot allocation by at least part of the unutilized one or more resources for at least a period, or (ii) responsive to transmitting or receiving the second indicator, adding at least one resource to at least a period.

The first network node and the second network node, respectively, may include one of a gNB, an eNB, and a UE.

When the first network node includes a gNodeB or an eNodeB, the periodic multi-slot allocation may include a periodic multi-slot PDSCH SPS.

When the second network node includes a UE, the periodic multi-slot allocation may include a periodic multi-slot PUSCH CG.

In some embodiments, the one or more resources include one or more transport blocks (TBs), or one or more HARQ processes.

The indicator may include one of an explicit indicator, and an implicit indicator from which a receiver of the second network node can derive the indicator from a policy.

In some embodiments, the first indicator further includes information indicating at least one of (i) a number of periods for which the reducing applies, and (ii) a pattern of periods for which the reducing applies.

Still referring to FIG. 11, the method may further include transmitting (1107) information indicating a size change of the periodic multi-slot allocation. The size change may include one of (i) a reduction in a size of the periodic multi-slot allocation in at least a period, (ii) an increase in a size of the periodic multi-slot allocation in at least a period, or (iii) a combination of a reduction and an increase in a size of the periodic multi-slot allocation in at least a period.

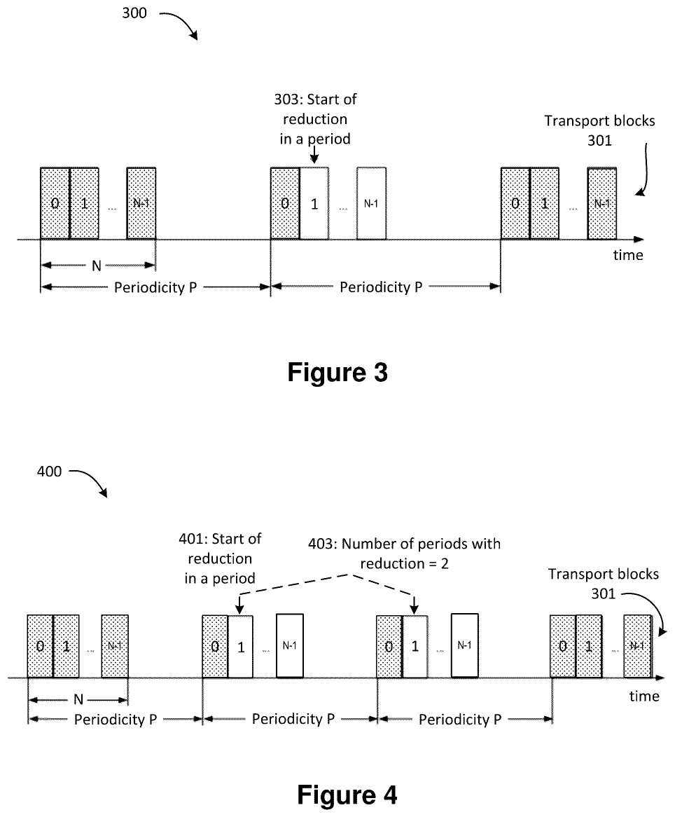

FIG. 3 is a schematic diagram 300 illustrating an example embodiment of reduction of multi-PxSCH size in one period. In this example embodiment, a periodically scheduled transmission is scheduled to recur with a periodicity of P, where the transmission may be either SPS PDSCH for DL data or CG PUSCH for UL data. At each period, N TBs 301 are pre-scheduled as illustrated by the patterned TBs, if no further indication is received to change the resource scheduling. While the N TBs are illustrated to occupy adjacent resources, the method is not so limited and the N PxSCHs for the N TBs 301 may or may not occupy adjacent resources. For example, there may or may not be spaces separating two consecutive PxSCH within one period. As illustrated in this example embodiment, a first indication is provided to notify the reduction of multi-PxSCH for the second period at start 303, where the resources for TB₁ . . . TB_{N-1} are not occupied as illustrated by the non-patterned TBs in the second period (that is, no data was sent for TB₁ . . . . TB_{N-1}), and the second period is reduced to be TB₀ only. The first indication in this example embodiment is for an individual period, illustrated as the second period in FIG. 3.

Another example embodiment is illustrated in FIG. 4. FIG. 4 is a schematic diagram 400 illustrating a reduction of multi-PxSCH size in Np=two consecutive periods. In this example embodiment, the first indication provides two information: (a) the start 401 of reduction of multi-PxSCH in an period; (b) the number of periods Nₚ that the reduction applies 403. In the example embodiment in FIG. 4, the first indication indicates/notifies that: (a) no data was sent for TB₁ . . . TB_{N-1} (that is, the resources in one period is reduced to be the PxSCH for TB₀ only), and (b) this reduction is applied for Nₚ=2 consecutive periods, illustrated in FIG. 4 as the second period and the third period.

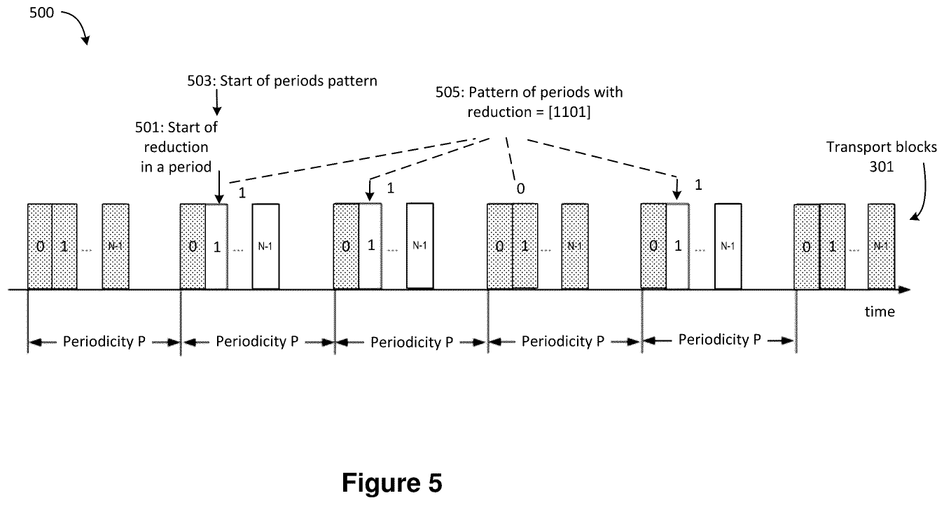

FIG. 5 is a schematic diagram 500 illustrating another example embodiment of reduction of multi-PxSCH size in a sequence of consecutive periods, where the periods pattern in [1 1 0 1], with “1” indicating that the reduction is applied in the corresponding period and “0” indicating that the reduction is not applied. In this example embodiment, the first indication provides two information: (a) the start 501 of reduction of multi-PxSCH in an period; (b) the pattern of periods that the reduction may apply 505. In the example embodiment of FIG. 5, the first indication indicates/notifies that, (a) no data was sent for TB₁ . . . TB_{N-1} (that is, the resources in one period is reduced to be the PxSCH for TB₀ only) in a period with reduction, and (b) this reduction is applied for period pattern [1 1 0 1] (that is, the reduction is applied to the first, second, and fourth period (staring 501 with the first period), but not third period in the pattern).

The method of the present disclosure may further include signaling of the indicator to indicate a size change of a periodic multi-slot allocation (e.g., a periodic multi-PxSCH). While example embodiments discussed herein discuss the reduction of a periodic multi-slot allocation size, the method is not so limited and includes signaling an increase of a periodic multi-slot allocation size, or signaling a mixture of increase and decrease of a periodic multi-allocation size.

Referring to FIG. 11, the information transmitted (1107) indicating a size change of the periodic multi-slot allocation may be transmitted in one of the indicator or in control signaling. In an example embodiment, the first network node transmits the indication over control signaling that can be multiplexed or included in PUSCH(s)/PDSCH(s) which are part of the periodic multi-slot allocation in the period. The control signaling can indicate which resources remain unused and/or which resources are used within period. In some embodiments, the control signaling is one of UCI; CG-UCI multiplexed with PUSCH; MAC-CE in PUSCH; some sequence based in an UL scenario; DCI multiplexed with PDSCH; MAC-CE in PDSCH; and/or some sequence based in a DL scenario; etc.

The control signaling may indicate the one or more resources that are unutilized and/or the one or more resources that have a shortage within at least the period. In an example embodiment, if the first network node is unable to transmit over a first X occasions or multi-slot occasions or resources in a period, the first network node loses the right to transmit on the remaining resources in the same period. Thus, on the network node receiver side, if a corresponding receiver of the network node does not detect transmission over X occasions, the network node will not monitor the remaining occasions for the network node for the intended traffic.

In some embodiments, the control signaling indicates a number of HARQ processes, a number of TBs, or a number of occasions within at least the period that will be unutilized for data transmission. In an example embodiment, the first network node (e.g., gNB or UE) transmits control signaling indicating the number of HARQ processes or TBs or occasions within a period that will not be used for data transmissions. For example, if a period (e.g., for a given SPS/CG ID) contains ten HARQ process allocations, the first network node can send control signaling indicating a value or identification (ID) that maps, e.g. to five to ten PxSCHs from ten PxSCHs (TBs) will not be transmitted or barred from being transmitted. In some embodiments, the control signaling can be DCI/UCI/MAC-CE based depending on the first network node that sends it (e.g., gNB or UE). It is noted that these values can be configured in a RRC setup or during activation of periodic allocation (e.g., via DCI/RRC based) indicating the number of options so that first network node can indicate the desired option in the control signaling.

In some embodiments, the information transmitted in at least the period applies to a later period of the periodic multi-slot allocation. In another embodiment, the information transmitted in at least the period applies to a specified duration of a later period of the periodic multi-slot allocation. In an example embodiment, the indicator or control signaling sent in period X of a CG/SPS applies to period Y of the same CG/SPS, where Y≥X. For example, in period X of CG, a first network node (e.g., a UE) indicates it will utilize only 50% of multi-PUSCH occasions, then this is applicable for period Y, and the Y=X+1 next period. Thus, in this example, a gNB in X+1 period will monitor only half of multi-PUSCH occasions for this UE as the other half does not contain data as per the UE's indication in the previous period.

The indicator or the control signaling may be applicable for (i) a plurality of CGs when the first network node network node includes a UE, or (ii) a plurality of SPS periodic multi-slot allocations when the first network node comprises a gNB or an eNB. In an example embodiment, the indicator or control signaling sent in period X of a CG/SPS applies to period Y until period Y+D of the same CG/SPS where Y≥X and each of X, Y, D are positive. For example, for an SPS with ten PDSCHs allocated per period, a first network node (e.g., a gNB) can send an indicator in period N indicating that the last two PDSCHs (e.g., PDSCH #9, PDSCH #10) in a period from period N to N+D will be not used to transmit PDSCHs, thus the second network node (e.g., a UE) can skip the monitoring.

In some embodiments, the one or more resources include one or more TBs, or one or more HARQ process, and the indicator is transmitted in at least one of (i) a first occasion of a first TB or a first HARQ process in the periodic multi-slot allocation, (ii) all occasions of TBs or HARQ processes in the periodic multi-slot allocation, and (iii) at least a time interval before a TB or a HARQ process that enables decoding of the indicator. In an example embodiment, the indicator is transmitted, without limitation, as follows: (i) a first occasion, first TB, or first HARQ process in a periodic multi-slot (e.g., multi-PXSCH) allocation (along with data); (ii) all occasions or TBs or HARQ processes in a periodic multi-slot allocation (along with data); or (iii) at least t time unit before an occasion, TB, or HARQ process in a periodic multi-slot allocation (along with data) which enables the indicator decoding.

In an example embodiment, the indicator or control signaling can contain the following information, without limitation: SPS/CG ID; resource/occasions/HARQ processes/TBs/multi-slot occasions to be used/unused; which period the effect of signaling applies to (e.g., same period X or other period Y); a number of periods the effect of signaling applies to (e.g., D+1 periods), etc.

In another embodiment, the indicator or control signaling can be applicable for multiple periodic multi-slot allocations (e.g., multiple CGs/SPSs). For example, if a UE is utilizing multiple CGs to transmit multiple PUSCHs, then the UE can include the indicator in one or some or all CGs indicating which PUSCHs are used/unused. In an example embodiment, a UE is allocated four CGs with a same periodicity, however, their PUSCHs are consecutive. Thus, with four CGs, the UE can transmit four consecutive PUSCHs. Further, in some period, the UE can send the indicator indicating that the UE will not utilize the last two PUSCHs out of four where the group of PUSCHs are formed by combing the CGs.

The indicator may further include an indication of a configuration that determines the one or more resources that are unutilized or have a shortage in at least the period. In an example embodiment, the indicator can indicate the configuration that determines which PxSCHs are used or not in period or group of periods. The configuration can be directly indicated in the indicator signaling or maps to IDs which may be defined in an RRC configuration.

Referring to FIG. 11, the method may further include receiving (1101) activation signaling of (i) a semi-persistent scheduling, SPS, periodic multi-slot allocation when the first network node comprises a gNodeB or an eNodeB, or (ii) a configured grant when the first network node comprises a user equipment, UE. The activation signaling indicates whether the indicator is enabled or not enabled and, when enabled, the activation signaling further indicates the periodic multi-slot allocation, and rules for the indicator.

In an example embodiment, the activation signaling (e.g., DCI/RRC) of a SPS/CG can indicate if the indication is enabled or disabled. If enabled, the activation signaling may identify what is the allocation; rules where the indicator can be sent; and/or what is the period, or groups of periods, for which the indicator can be applied.

The indicator may be multiplexed with other information including control information. In an example embodiment, the indicator can be multiplexed with other control information such as with DCI in DL or with HARQ-ACK/CSI/SR in UL.

The indicator may further indicate a probability value for the one or more resources remaining unutilized for future periods. In an example embodiment, the indicator, apart from indicating that a subset of allocation from multiple transmissions within a period remain unutilized, can also indicate a probability value for the subset to remain unutilized for future periods. For example, for four multi-PUSCH transmissions (e.g., four consecutive slots) with a period of twenty slots where in the first period the PUSCH transmissions are in slots 0, 1, 2, and 3 while in the second period the PUSCH transmissions are in slots 20, 21, 22, and 23. Upon the first period, a UE may determine that only the PUSCH transmissions in slots 0 and 1 will be used, but the UE may also determine based on its knowledge about data time-jitter there was a 25% and 0% probability, respectively, that the UE would have used slots 2 and 3. The UE then transmits the indicator indicating that slots 2 and 3 are unutilized and an indicator indicating the probabilities 20% and 0% for the unutilized slots 2 and 3, respectively. Upon reception of the indicator, a gNB realizes that slots 2 and 3 will not be used by the UE for the first period and also that there is only 25% probability that slots n (mod 20)=2 will be used and 0% probability that slots n (mod 20)=3 will be used by the UE. The gNB can then safely utilize slots n (mod 20)=3 for other UEs since the UE that holds the allocation will never use it. The gNB can also modify the four multi-PUSCH to a two multi-PUSCH for a considered UE, and then for the 25% of the cases when the UE needs to be allocated in slots n (mod 20)=3, schedule the UE using dynamic allocation.

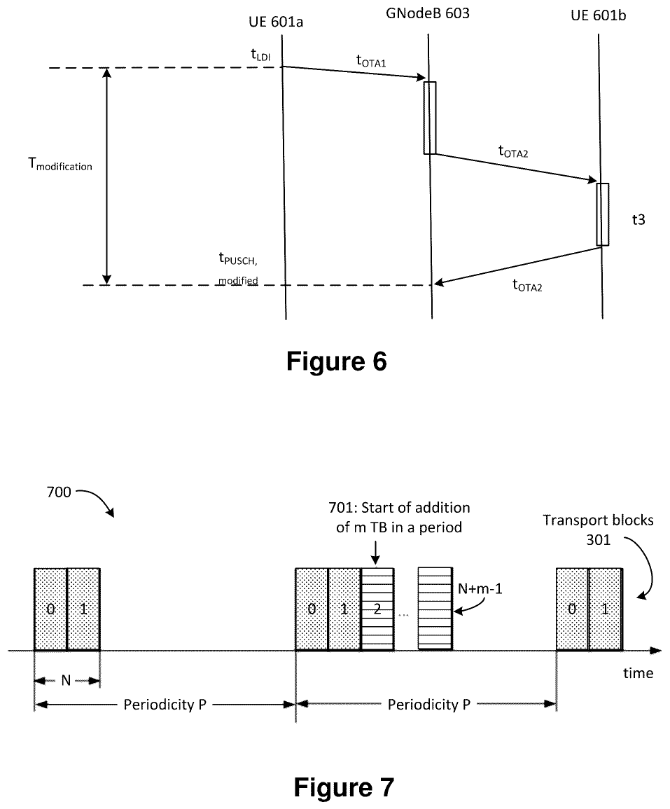

The method of the present disclosure may further include indicator restriction for periodic multi-slot allocation modification. Upon reception of the indicator, the first network node can schedule another scheduling entity to reuse the resource(s) that is freed up indicated with the indicator indicating a multi-slot modification. However, at times, it may take time for the second network node (e.g., a UE) to free up a resource so that it can be useable to other network nodes (e.g., other UEs), as illustrated in FIG. 6. As illustrated in FIG. 6, tLDI is the time instance that a first UE (UE1) makes a modification decision and sends the modification indicator, and tPUSCH, modified is the PUSCH transmission time that the decision of modification is applied. tPUSCH, modified includes the time for the indicator message over the air, and the scheduling time of a second UE (UE2), which includes the processing time of a first network node (e.g., nodeB (or gNB)), UE2, and one round trip time over the air of the UE2.

Referring to FIG. 11, the method may further include, responsive to transmitting the first indicator, scheduling (1109) the second network node or another entity in the communication system to use the unutilized one or more resources from at least the period.

In some embodiments, the scheduling occurs responsive to the first network node freeing the unutilized one or more resources before a modification to add one or more resources occurs. In an example embodiment, a restriction is included that the second network node (e.g., a UE) can only modify the PUSCH, which is Tmodification ahead, if the modification is to add more PUSCH slot and the first network node (e.g., nodeB) scheduling needs to free up the resources before the modification occurs. If reduction of the transmission slot, and if reuse of the resources is not required, Tmodification ahead is not needed.

In some embodiments, the scheduling occurs responsive to a timing signal. For example, as illustrated in FIG. 6, when the network signal Tmodification is sent to the UE1, UE1 can make the modification decision ahead based on a pre-calculation. Another example embodiment includes separately signaling a separate time offset of reducing or increasing resources, e.g. Taddslot, Treduceslot. The signal to carry the time offset may be RRC/MAC signaling.

In some embodiments, the scheduling occurs based on a time interval associated with a quality of service (QOS) transmitted by the first network node. For example, as illustrated in FIG. 6, the tPUSCH, modified may depend on a QoS UE1 is transmitting. The higher the QoS priority, the shorter tPUSCH, modified ndi may be.

In some embodiments, the scheduling occurs based on a modification request that is approved by the first network node. For example, a second network node (e.g., a UE) can send a modification request that when approved by the first network node, the modification can be applied (e.g., increasing a resource).

The method of the present disclosure may further include indicator utilization to indicate a modulation coding scheme (MCS)/encoding parameter changes. A channel condition of a resource allocation can change. This may allow a network node (e.g., a UE) to pack more or less bits/data in ae per-configured resource allocation (e.g., CG/SPS) if the channel has changed in order to have a same block error rate (BLER) target.

Referring to FIG. 11, the method may further include transmitting (1111) a MCS that indicates that additional bits per a resource in the periodic multi-slot allocation can be packed; and releasing (1113) one or more of the resources based on the second network node being able to pack more bits per the resource. For example, if channel conditions have improved, the transmitter can indicate an increased MCS size (e.g., ability to pack more bits per TB in the periodic multi-slot allocation); and notify the release of some multi-slot resources/occasions, as the transmitter is able to pack more bits per PxSCH/TB, it therefore needs less PxSCHs from the multi-PxSCH allocation.

The indicator may further indicate the MCS in a period. For example, the indicator can also indicate a MCS or change/difference in MCS for the multi-slot occasions in a period (e.g., same/other/next period).

A size of a physical resource block, PRB, of the periodic multi-slot allocation may remain the same and the indicator may further indicate a change in the MCS. For example, the PRB size (e.g., TDRA/FDRA) size of the periodic multi-slot allocation remains the same, and only a change(s) to MCS is indicated.

The indicator may be encoded and/or decoded independently of encoding and/or decoding of the one or more resources. For example, the indicator can be encoded/decoded independently of PxSCH/TB encoding/decoding because it may be desirable to change parameters of PXSCH via the indicator LDI. Thus, the indicator parameters may be kept fixed in order to have decoding of the indicator at a receiver of the second network node without a blind-decoding procedure.

The first network node may select the MCS from a range of MCS and may include the selected MCS in the indicator. For example, the first network node can configure a range/table of MCS (e.g., some values from maximum to minimum) for which the first network node is allowed to select a desired MCS (e.g., based on channel conditions or its traffic requirement). The first network node (e.g., UE or gNB) can choose the desired MCS from the range, and indicate the MCS difference or absolute value in the indicator.

As previously discussed, in some embodiment, addition is included to the periodic multi-slot allocation. For example, the indicator may notify that more PxSCHs are added to the periodically scheduled resources. As referred to herein, since one PxSCH corresponds to one TB, addition of PxSCHs is also understood as addition of TBs.

In some embodiments, adding the one or more resource includes adding one or more TBs to the periodic multi-slot allocation in at least the period.

The second indicator may further include information indicating at least one of (i) an identity of one or more periods in which to add the one or more TBs, (ii) where to add the one or more TBS in one or more periods, and (ii) a pattern of periods for which the adding applies.

Referring to FIG. 11, in some embodiments, the performing the reducing and/or the performing the adding is performed in a recurring periodic multi-slot allocation pattern.

In an example embodiment, the periodically scheduled transmission is scheduled to recur with a periodicity of P, where the transmission can be either SPS PDSCH for DL data or CG PUSCH for UL data. At each period, N TBs are pre-scheduled, if no further indicator is received to change the resource scheduling. While the N TBs are illustrated to occupy adjacent resources embodiments discussed below, the method is not so limited. Instead, the N PxSCHs for the N TBs of such example embodiments may or may not occupy adjacent resources. That is, there may or may not be spaces separating two consecutive PxSCH within one period.

FIG. 7 is a schematic diagram 700 illustrating an example embodiment of addition of TBs 301 in one period of multi-PxSCH. As illustrated in FIG. 7, at each period of the periodically scheduled transmission, N=2 TBs are pre-scheduled, if no further indication is received to change the resource scheduling. As illustrated in this example embodiment, the indicator is provided to notify the addition of further PxSCH starting 701 in the second period, where m PxSCHs for m TBs are appended to the resources for TB₀ . . . TB_{N-1} (that is, TB₀, TB₁ in FIG. 7). This indicator is for an individual period, e.g., the second period as illustrated in FIG. 7.

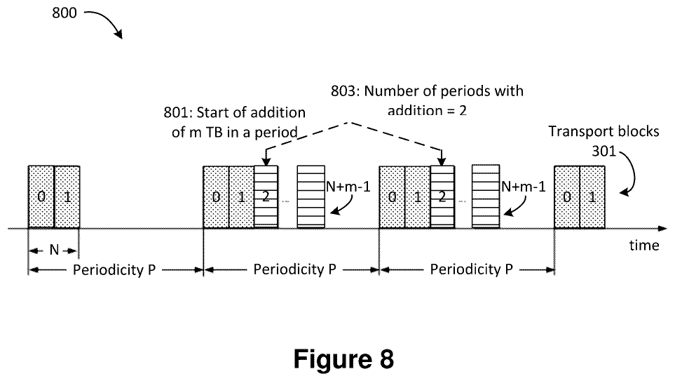

FIG. 8 is a schematic diagram 800 illustrating an example embodiment of addition of TBs 301 in two consecutive periods of multi-PxSCH. As illustrated in FIG. 8, the indicator provides two information: (a) the addition of further PxSCH in a period, where m PxSCHs for m TBs are appended to the resources for TB₁ . . . TB_{N-1} in a period; and (b) the number of periods Nₚ that the addition applies to. As illustrated in the example embodiment of FIG. 8, the indicator notifies that: (a) m PxSCHs for m TBs are appended to the resources for TB₀ and TB₁ in a period, and (b) this addition is applied 803 for Nₚ=2 consecutive periods (starting 801 in the second period for the second period and the period of FIG. 8).

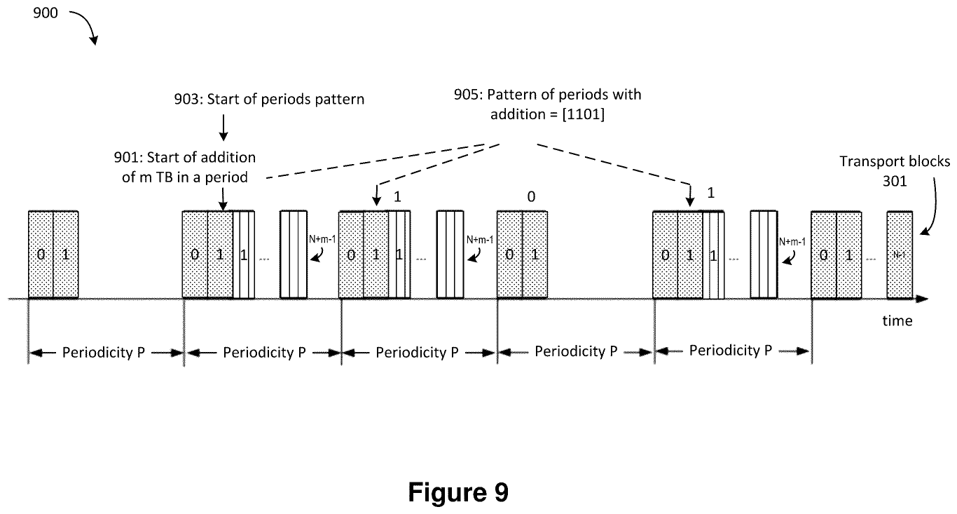

FIG. 9 is a schematic diagram 900 illustrating another example embodiment of addition of TBs 301 in a sequence of consecutive periods, where the periods pattern is [1 1 0 1], with “1” indicating that the addition is applied in the corresponding period, and “0” indicating that the addition is not applied. As illustrated in FIG. 9, the indicator provides two information: (a) the addition of m PxSCH in a period; and (b) the pattern of periods that the addition may apply. As illustrated in the example embodiment of FIG. 9, the indicator notifies that, (a) m PxSCHs for m TBs are appended to the resources for TB₀ and TB₁ in a period, and (b) this addition is applied 905 for period pattern [1 1 0 1] (that is in FIG. 9, the addition is applied, starting 901 in the start 903 of the periods pattern in the first period, to the first, second, and fourth periods, but not the third period in the pattern).

Signaling of the method (e.g., transmitting and/or receiving) may include, in the case of DL SPS, the first network node (e.g., a gNB) can indicate (a) via flag/MAC CE regarding an addition of TBs/resources (see e.g., TBs 301 with lines in FIGS. 7-9) in the PDSCHs transmitted over active TB resources (see e.g., dotted TBs 301 in FIGS. 7-9) or (b) via DCI. The DCI may or may not be multiplexed with the dotted TBs 301 in FIGS. 7-9. The addition of TB resources can apply within the same period or the period can start from x time units after sending the indicator. In case of UL CG, the first network node (e.g., gNB) can send the indicator (a) via DCI or (b) MAC CE in DL to notify of the changes regarding addition of TB resources in a period(s). On the other hand, a UE can send (a) UCI or SR regarding addition of more TBs per CG (and the gNB can notify via DCI/MAC CE) or (b) UCI regarding autonomous use of more TBs. In the example embodiment of FIG. 7, for example, a UE can include UCI in the dotted TBs 301 to indicate addition of the lined TBs 301.

Reduction and addition of multi-slot allocation (e.g., PxSCH) may be used simultaneously in a period in the recurring, periodic multi-slot allocation pattern (e.g., in the recurring, periodic multi-PxSCH pattern). For example, a value can be used to indicate the change of multi-PxSCH size, with a positive value indicating an increase of PxSCH, and a negative value indicating a decrease of PxSCH, where the increase/decrease is relative to the pre-configured, recurring, size. In an example embodiment, the modification signaling (e.g., the indicator or addition related signaling) can be decoded separately from PXSCH If included or multiplexed alongside. The signaling's MCS and encoding/decoding parameters can be fixed whereas PxSCH can have flexible parameters. This may allow a network node to modify (e.g., add and/or reduce) TBs resources if the transmitter is able to pack less or more data bits per TB from a last MCS value.

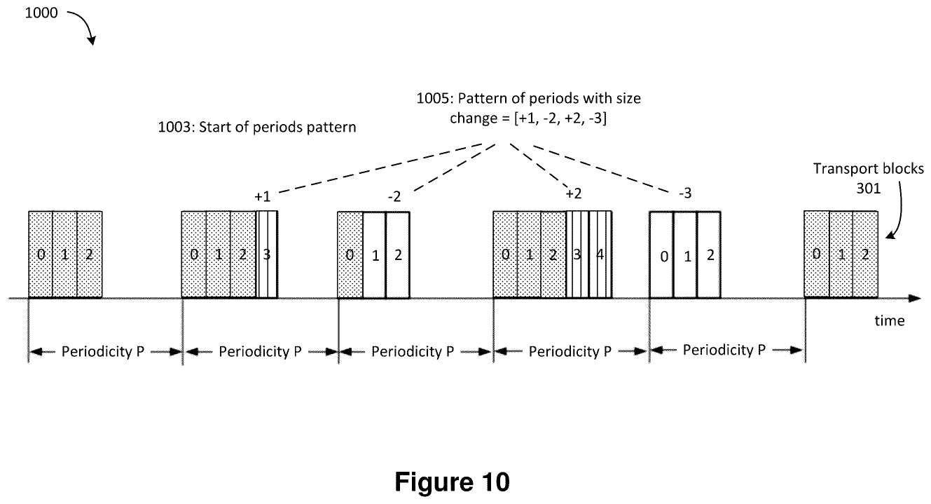

FIG. 10 is a schematic diagram 1000 illustrating an example embodiment of changing multi-PxSCH size in a sequence of consecutive periods, where the periods pattern is [+1, −2, +2, −3]. The entry value in the pattern indicates the addition or reduction of PxSCH in the corresponding period, with a positive value indicating addition of PxSCH, and a negative value indicating reduction of PxSCH. As illustrated in FIG. 10, a period pattern 1005 of four entries, [+1, −2, +2, −3] is used to indicate size modification for four consecutive periods. The entry values “+1” and “+2” indicate that one and two additional TBs 301 are appended to the pre-configured size of three TBs 301 in a period staring 1003 with the first period, for the first and third period in the pattern, respectively. Similarly, “−2” and “−3” indicate that two and three TBs 301 are removed from the pre-configured size of three TBs 301 in a period, for the second and fourth period in the pattern, respectively.

Various operations from the flow chart of FIG. 11 may be optional with respect to some embodiments of first network nodes and related methods. For example, the operations of blocks 1101, and 1107-1113 may be optional.

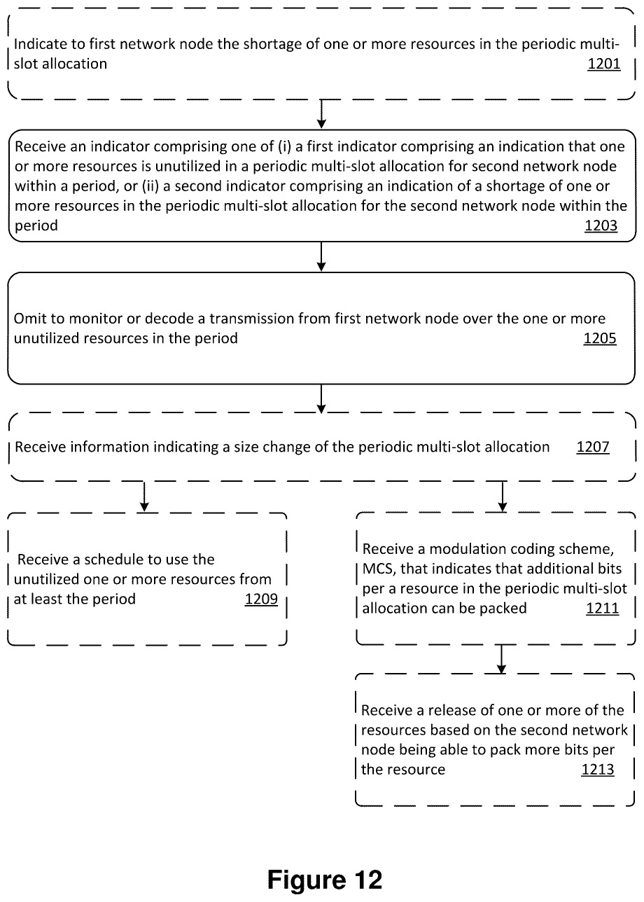

FIG. 12 is a flow chart illustrating operations of a method performed by a second network node (e.g., network node 13112/14200, 13110/15300, 13112B) in a communication system. The method includes receiving (1203) an indicator from a first network node including one of (i) a first indicator including an indication that one or more resources is unutilized in a periodic multi-slot allocation for the second network node within a period, or (ii) a second indicator including an indication of a shortage of one or more resources in the periodic multi-slot allocation for the second network node within the period. The method further includes, responsive to receiving the first indicator, omitting (1205) to monitor or decode a transmission from the first network node over the one or more unutilized resources in the period.

The method may further include indicating (1201) to the first network node the shortage of one or more resources in the periodic multi-slot allocation. The indicating may be included in at least one of a buffer status report, BSR, an uplink control information, UCI, and a scheduling request, SR.

The first and the second network node, respectively, may include one of a user equipment, UE, a gNB, and an eNB. When the first network node includes a gNB or an eNB, the periodic multi-slot allocation may include a periodic multi-slot PDSCH SPS. When the second network node includes a UE, the periodic multi-slot allocation may include a periodic multi-slot PUSCH CG.

The one or more resources may include one or more TBs, or one or more HARQ processes.

The indicator may include one of an explicit indicator, and an implicit indicator from which a receiver of the second network node can derive the indicator from a policy.

The first indicator may further include information indicating at least one of (i) a number of periods for which the reducing applies, and (ii) a pattern of periods for which the reducing applies.

Referring to FIG. 12, the method may further include receiving (1207) information indicating a size change of the periodic multi-slot allocation. The size change may include one of (i) a reduction in a size of the periodic multi-slot allocation in at least a period, (ii) an increase in a size of the periodic multi-slot allocation in at least a period, or (iii) a combination of a reduction and an increase in a size of the periodic multi-slot allocation in at least a period.

The information may be received in one of the indicator or in control signaling. The control signaling may indicate the one or more resources that are unutilized and/or the one or more resources that have a shortage within at least the period. The control signaling may indicate a number HARQ processes, a number of TBs, or a number of occasions within at least the period that will be unutilized for data transmission.

The information transmitted in at least the period may apply to a later period of the periodic multi-slot allocation. The information transmitted in at least the period may apply to a specified duration of a later period of the periodic multi-slot allocation.

The indicator or the control signaling may be applicable for (i) a plurality of CGs when the second network node includes a UE, or (ii) a plurality of SPS periodic multi-slot allocations when the first network node comprises a gNB or an eNB.

The one or more resources may include one or more TBs, or one or more HARQ process, and the indicator may be transmitted in at least one of (i) a first occasion of a first TB or a first HARQ process in the periodic multi-slot allocation, (ii) all occasions of TBs or HARQ processes in the periodic multi-slot allocation, and (iii) at least a time interval before a TB or a HARQ process that enables decoding of the indicator.

The indicator may further include an indication of a configuration that determines the one or more resources that are unutilized or have a shortage in at least the period.

The indicator may be multiplexed with other information including control information.

The indicator may further indicate a probability value for the one or more resources remaining unutilized for future periods.

Referring to FIG. 12, the method may further include receiving (1209) a schedule to use the unutilized one or more resources from at least the period. The schedule may occur responsive to the first network node freeing the unutilized one or more resources before a modification to add one or more resources occurs. The schedule may occur responsive to a timing signal. In another embodiment, the schedule may occur based on a time interval associated with a QoS transmitted by the first network node. In yet another embodiment, the schedule may occur based on a modification request that is approved by the first network node.

Referring to FIG. 12, the method may further include receiving (1211) a MCS that indicates that additional bits per a resource in the periodic multi-slot allocation can be packed; and receiving (1213) a release one or more of the resources based on the second network node being able to pack more bits per the resource.

The indicator may further indicate the MCS in a period.

A size of a physical resource block (PRB) of the periodic multi-slot allocation may remain the same and the indicator may further indicate a change in the MCS.

The indicator may be encoded and/or decoded independently of encoding and/or decoding of the one or more resources.

The first network node may select the MCS from a range of MCS and may include the selected MCS in the indicator.

In some embodiments, adding the one or more resource includes adding one or more TBs to the periodic multi-slot allocation in at least the period.

In some embodiments, the second indicator further includes information indicating at least one of (i) an identity of one or more periods in which to add the one or more TBs, (ii) where to add the one or more TBS in one or more periods, and (ii) a pattern of periods for which the adding applies.

In some embodiments, the performing the reducing and/or the performing the adding is performed in a recurring periodic multi-slot allocation pattern.

Various operations from the flow chart of FIG. 12 may be optional with respect to some embodiments of second network nodes and related methods. For example, the operations of blocks 1201, and 1207-1213 may be optional

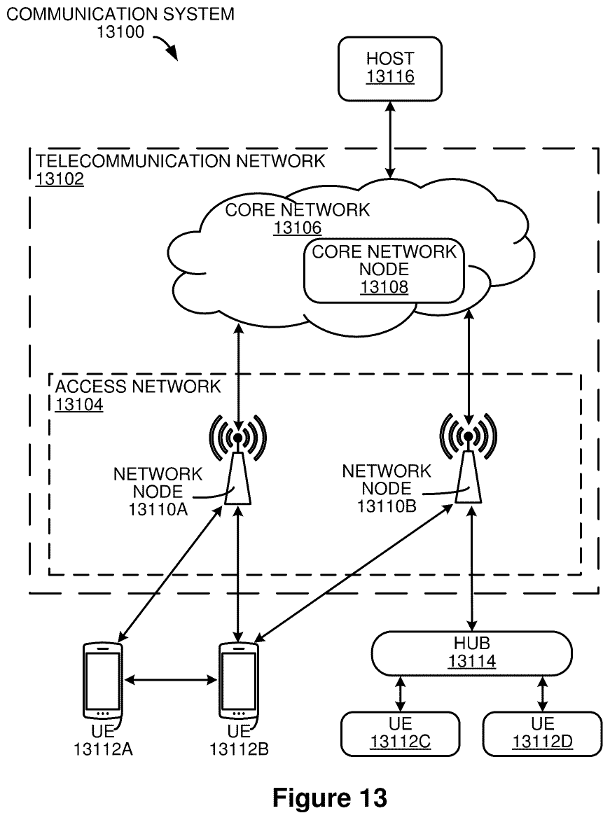

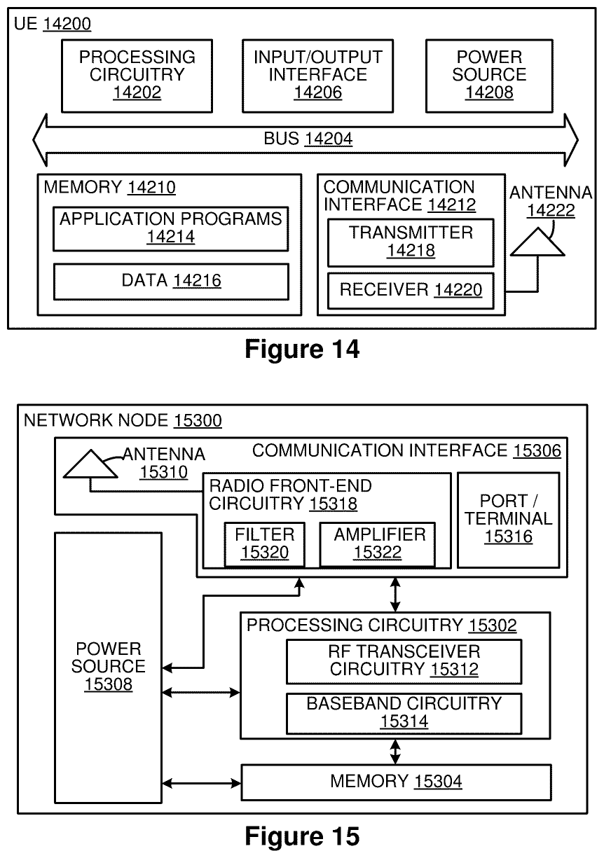

The method of a first network node of the present disclosure may be performed by, e.g., network node 13110 of FIG. 13, network node 15300 of FIG. 15, network node 13112 of FIG. 13 (also referred to herein as UE 13112), or network node 14200 of FIG. 14 (also referred to herein as UE 14200). For example, modules may be stored in memory 15304 of FIG. 15 or memory 14210 of FIG. 14, and these modules may provide instructions so that when the instructions of a module are executed by processing circuitry 15302 of FIG. 15 or processing circuitry 14202 of FIG. 14, the first network node performs respective operations of the method in accordance with various embodiments of the present disclosure.

The method of a second network node of the present disclosure may be performed by, e.g., network node 13112 of FIG. 13 (also referred to herein as UE 13112), network node 14200 of FIG. 14 (also referred to herein as UE 14200), network node 13110 of FIG. 13, or network node 15300 of FIG. 15. For example, modules may be stored in memory 14210 of FIG. 14 or memory 15304 of FIG. 15, and these modules may provide instructions so that when the instructions of a module are executed by processing circuitry 14202 of FIG. 14 or processing circuitry 15302 of FIG. 15, the second network node performs respective operations of the method in accordance with various embodiments of the present disclosure.

FIG. 13 shows an example of a communication system 13100 in accordance with some embodiments.

In the example, the communication system 13100 includes a telecommunication network 13102 that includes an access network 13104, such as a radio access network (RAN), and a core network 13106, which includes one or more core network nodes 13108. The access network 13104 includes one or more access network nodes, such as network nodes 13110a and 13110b (one or more of which may be generally referred to as network nodes 13110), or any other similar 3GPP access node or non-3GPP access point. The network nodes 13110 facilitate direct or indirect connection of UE, such as by connecting UEs 13112a, 13112b, 13112c, and 13112d (one or more of which may be generally referred to as UEs 13112) to the core network 13106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 13100 may include any number of wired or wireless networks, network nodes, UEs, and/or any other components or systems that may facilitate or participate in the communication of data and/or signals whether via wired or wireless connections. The communication system 13100 may include and/or interface with any type of communication, telecommunication, data, cellular, radio network, and/or other similar type of system.

The UEs 13112 may be any of a wide variety of communication devices, including wireless devices arranged, configured, and/or operable to communicate wirelessly with the network nodes 13110 and other communication devices. Similarly, the network nodes 13110 are arranged, capable, configured, and/or operable to communicate directly or indirectly with the UEs 13112 and/or with other network nodes or equipment in the telecommunication network 13102 to enable and/or provide network access, such as wireless network access, and/or to perform other functions, such as administration in the telecommunication network 13102.

In the depicted example, the core network 13106 connects the network nodes 13110 to one or more hosts, such as host 13116. These connections may be direct or indirect via one or more intermediary networks or devices. In other examples, network nodes may be directly coupled to hosts. The core network 13106 includes one more core network nodes (e.g., core network node 13108) that are structured with hardware and software components. Features of these components may be substantially similar to those described with respect to the UEs, network nodes, and/or hosts, such that the descriptions thereof are generally applicable to the corresponding components of the core network node 13108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 13116 may be under the ownership or control of a service provider other than an operator or provider of the access network 13104 and/or the telecommunication network 13102, and may be operated by the service provider or on behalf of the service provider. The host 13116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 13100 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 13102 is a cellular network that implements 3GPP standardized features. Accordingly, the telecommunications network 13102 may support network slicing to provide different logical networks to different devices that are connected to the telecommunication network 13102. For example, the telecommunications network 13102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 13112 are configured to transmit and/or receive information without direct human interaction. For instance, a UE may be designed to transmit information to the access network 13104 on a predetermined schedule, when triggered by an internal or external event, or in response to requests from the access network 13104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 13114 communicates with the access network 13104 to facilitate indirect communication between one or more UEs (e.g., UE 13112c and/or 13112d) and network nodes (e.g., network node 13110b). In some examples, the hub 13114 may be a controller, router, content source and analytics, or any of the other communication devices described herein regarding UEs. For example, the hub 13114 may be a broadband router enabling access to the core network 13106 for the UEs. As another example, the hub 13114 may be a controller that sends commands or instructions to one or more actuators in the UEs. Commands or instructions may be received from the UEs, network nodes 13110, or by executable code, script, process, or other instructions in the hub 13114. As another example, the hub 13114 may be a data collector that acts as temporary storage for UE data and, in some embodiments, may perform analysis or other processing of the data. As another example, the hub 13114 may be a content source. For example, for a UE that is a VR headset, display, loudspeaker or other media delivery device, the hub 13114 may retrieve VR assets, video, audio, or other media or data related to sensory information via a network node, which the hub 13114 then provides to the UE either directly, after performing local processing, and/or after adding additional local content. In still another example, the hub 13114 acts as a proxy server or orchestrator for the UEs, in particular in if one or more of the UEs are low energy IoT devices.

The hub 13114 may have a constant/persistent or intermittent connection to the network node 13110b. The hub 13114 may also allow for a different communication scheme and/or schedule between the hub 13114 and UEs (e.g., UE 13112c and/or 13112d), and between the hub 13114 and the core network 13106. In other examples, the hub 13114 is connected to the core network 13106 and/or one or more UEs via a wired connection. Moreover, the hub 13114 may be configured to connect to an M2M service provider over the access network 13104 and/or to another UE over a direct connection. In some scenarios, UEs may establish a wireless connection with the network nodes 13110 while still connected via the hub 13114 via a wired or wireless connection. In some embodiments, the hub 13114 may be a dedicated hub—that is, a hub whose primary function is to route communications to/from the UEs from/to the network node 13110b. In other embodiments, the hub 13114 may be a non-dedicated hub—that is, a device which is capable of operating to route communications between the UEs and network node 13110b, but which is additionally capable of operating as a communication start and/or end point for certain data channels.

FIG. 14 shows a UE 14200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 14200 includes processing circuitry 14202 that is operatively coupled via a bus 14204 to an input/output interface 14206, a power source 14208, a memory 14210, a communication interface 14212, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 14202 is configured to process instructions and data and may be configured to implement any sequential state machine operative to execute instructions stored as machine-readable computer programs in the memory 14210. The processing circuitry 14202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 14202 may include multiple central processing units (CPUs).

In the example, the input/output interface 14206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 14200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 14208 is structured as a battery or battery pack. Other types of power sources, such as an external power source (e.g., an electricity outlet), photovoltaic device, or power cell, may be used. The power source 14208 may further include power circuitry for delivering power from the power source 14208 itself, and/or an external power source, to the various parts of the UE 14200 via input circuitry or an interface such as an electrical power cable. Delivering power may be, for example, for charging of the power source 14208. Power circuitry may perform any formatting, converting, or other modification to the power from the power source 14208 to make the power suitable for the respective components of the UE 14200 to which power is supplied.

The memory 14210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 14210 includes one or more application programs 14214, such as an operating system, web browser application, a widget, gadget engine, or other application, and corresponding data 14216. The memory 14210 may store, for use by the UE 14200, any of a variety of various operating systems or combinations of operating systems.

The memory 14210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 14210 may allow the UE 14200 to access instructions, application programs and the like, stored on transitory or non-transitory memory media, to off-load data, or to upload data. An article of manufacture, such as one utilizing a communication system may be tangibly embodied as or in the memory 14210, which may be or comprise a device-readable storage medium.

The processing circuitry 14202 may be configured to communicate with an access network or other network using the communication interface 14212. The communication interface 14212 may comprise one or more communication subsystems and may include or be communicatively coupled to an antenna 14222. The communication interface 14212 may include one or more transceivers used to communicate, such as by communicating with one or more remote transceivers of another device capable of wireless communication (e.g., another UE or a network node in an access network). Each transceiver may include a transmitter 14218 and/or a receiver 14220 appropriate to provide network communications (e.g., optical, electrical, frequency allocations, and so forth). Moreover, the transmitter 14218 and receiver 14220 may be coupled to one or more antennas (e.g., antenna 14222) and may share circuit components, software or firmware, or alternatively be implemented separately.

In the illustrated embodiment, communication functions of the communication interface 14212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 14212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 14200 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 15300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, eNBs and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 15300 includes a processing circuitry 15302, a memory 15304, a communication interface 15306, and a power source 15308. The network node 15300 may be composed of multiple physically separate components (e.g., a NodeB component and a RNC component, or a BTS component and a BSC component, etc.), which may each have their own respective components. In certain scenarios in which the network node 15300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 15300 may be configured to support multiple radio access technologies (RATs). In such embodiments, some components may be duplicated (e.g., separate memory 15304 for different RATs) and some components may be reused (e.g., a same antenna 15310 may be shared by different RATs). The network node 15300 may also include multiple sets of the various illustrated components for different wireless technologies integrated into network node 15300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 15300.

The processing circuitry 15302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 15300 components, such as the memory 15304, to provide network node 15300 functionality.

In some embodiments, the processing circuitry 15302 includes a system on a chip (SOC). In some embodiments, the processing circuitry 15302 includes one or more of radio frequency (RF) transceiver circuitry 15312 and baseband processing circuitry 15314. In some embodiments, the radio frequency (RF) transceiver circuitry 15312 and the baseband processing circuitry 15314 may be on separate chips (or sets of chips), boards, or units, such as radio units and digital units. In alternative embodiments, part or all of RF transceiver circuitry 15312 and baseband processing circuitry 15314 may be on the same chip or set of chips, boards, or units.

The memory 15304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 15302. The memory 15304 may store any suitable instructions, data, or information, including a computer program, software, an application including one or more of logic, rules, code, tables, and/or other instructions capable of being executed by the processing circuitry 15302 and utilized by the network node 15300. The memory 15304 may be used to store any calculations made by the processing circuitry 15302 and/or any data received via the communication interface 15306. In some embodiments, the processing circuitry 15302 and memory 15304 is integrated.

The communication interface 15306 is used in wired or wireless communication of signaling and/or data between a network node, access network, and/or UE. As illustrated, the communication interface 15306 comprises port(s)/terminal(s) 15316 to send and receive data, for example to and from a network over a wired connection. The communication interface 15306 also includes radio front-end circuitry 15318 that may be coupled to, or in certain embodiments a part of, the antenna 15310. Radio front-end circuitry 15318 comprises filters 15320 and amplifiers 15322. The radio front-end circuitry 15318 may be connected to an antenna 15310 and processing circuitry 15302. The radio front-end circuitry may be configured to condition signals communicated between antenna 15310 and processing circuitry 15302. The radio front-end circuitry 15318 may receive digital data that is to be sent out to other network nodes or UEs via a wireless connection. The radio front-end circuitry 15318 may convert the digital data into a radio signal having the appropriate channel and bandwidth parameters using a combination of filters 15320 and/or amplifiers 15322. The radio signal may then be transmitted via the antenna 15310. Similarly, when receiving data, the antenna 15310 may collect radio signals which are then converted into digital data by the radio front-end circuitry 15318. The digital data may be passed to the processing circuitry 15302. In other embodiments, the communication interface may comprise different components and/or different combinations of components.

In certain alternative embodiments, the network node 15300 does not include separate radio front-end circuitry 15318, instead, the processing circuitry 15302 includes radio front-end circuitry and is connected to the antenna 15310. Similarly, in some embodiments, all or some of the RF transceiver circuitry 15312 is part of the communication interface 15306. In still other embodiments, the communication interface 15306 includes one or more ports or terminals 15316, the radio front-end circuitry 15318, and the RF transceiver circuitry 15312, as part of a radio unit (not shown), and the communication interface 15306 communicates with the baseband processing circuitry 15314, which is part of a digital unit (not shown).

The antenna 15310 may include one or more antennas, or antenna arrays, configured to send and/or receive wireless signals. The antenna 15310 may be coupled to the radio front-end circuitry 15318 and may be any type of antenna capable of transmitting and receiving data and/or signals wirelessly. In certain embodiments, the antenna 15310 is separate from the network node 15300 and connectable to the network node 15300 through an interface or port.

The antenna 15310, communication interface 15306, and/or the processing circuitry 15302 may be configured to perform any receiving operations and/or certain obtaining operations described herein as being performed by the network node. Any information, data and/or signals may be received from a UE, another network node and/or any other network equipment. Similarly, the antenna 15310, the communication interface 15306, and/or the processing circuitry 15302 may be configured to perform any transmitting operations described herein as being performed by the network node. Any information, data and/or signals may be transmitted to a UE, another network node and/or any other network equipment.

The power source 15308 provides power to the various components of network node 15300 in a form suitable for the respective components (e.g., at a voltage and current level needed for each respective component). The power source 15308 may further comprise, or be coupled to, power management circuitry to supply the components of the network node 15300 with power for performing the functionality described herein. For example, the network node 15300 may be connectable to an external power source (e.g., the power grid, an electricity outlet) via an input circuitry or interface such as an electrical cable, whereby the external power source supplies power to power circuitry of the power source 15308. As a further example, the power source 15308 may comprise a source of power in the form of a battery or battery pack which is connected to, or integrated in, power circuitry. The battery may provide backup power should the external power source fail.

Embodiments of the network node 15300 may include additional components beyond those shown in FIG. 15 for providing certain aspects of the network node's functionality, including any of the functionality described herein and/or any functionality necessary to support the subject matter described herein. For example, the network node 15300 may include user interface equipment to allow input of information into the network node 15300 and to allow output of information from the network node 15300. This may allow a user to perform diagnostic, maintenance, repair, and other administrative functions for the network node 15300.

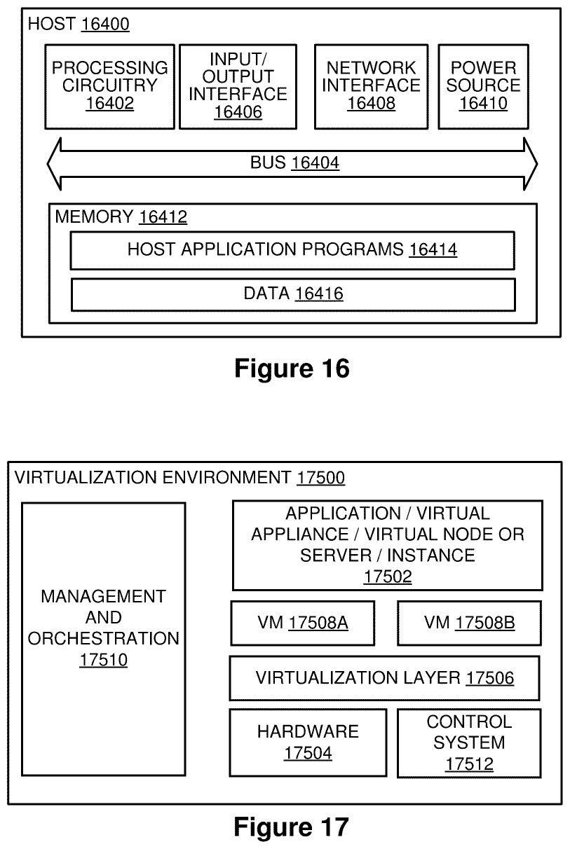

FIG. 16 is a block diagram of a host 16400, which may be an embodiment of the host 13116 of FIG. 13, in accordance with various aspects described herein. As used herein, the host 16400 may be or comprise various combinations hardware and/or software, including a standalone server, a blade server, a cloud-implemented server, a distributed server, a virtual machine, container, or processing resources in a server farm. The host 16400 may provide one or more services to one or more UEs.

The host 16400 includes processing circuitry 16402 that is operatively coupled via a bus 16404 to an input/output interface 16406, a network interface 16408, a power source 16410, and a memory 16412. Other components may be included in other embodiments. Features of these components may be substantially similar to those described with respect to the devices of previous figures, such as FIGS. 14 and 15, such that the descriptions thereof are generally applicable to the corresponding components of host 16400.

The memory 16412 may include one or more computer programs including one or more host application programs 16414 and data 16416, which may include user data, e.g., data generated by a UE for the host 16400 or data generated by the host 16400 for a UE. Embodiments of the host 16400 may utilize only a subset or all of the components shown. The host application programs 16414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 16414 may also provide for user authentication and licensing checks and may periodically report health, routes, and content availability to a central node, such as a device in or on the edge of a core network. Accordingly, the host 16400 may select and/or indicate a different host for over-the-top services for a UE. The host application programs 16414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 17500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 17500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 17502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 17504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 17506 (also referred to as hypervisors or virtual machine monitors (VMMs)), provide VMs 17508a and 17508b (one or more of which may be generally referred to as VMs 17508), and/or perform any of the functions, features and/or benefits described in relation with some embodiments described herein. The virtualization layer 17506 may present a virtual operating platform that appears like networking hardware to the VMs 17508.

The VMs 17508 comprise virtual processing, virtual memory, virtual networking or interface and virtual storage, and may be run by a corresponding virtualization layer 17506. Different embodiments of the instance of a virtual appliance 17502 may be implemented on one or more of VMs 17508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 17508 may be a software implementation of a physical machine that runs programs as if they were executing on a physical, non-virtualized machine. Each of the VMs 17508, and that part of hardware 17504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 17508 on top of the hardware 17504 and corresponds to the application 17502.

Hardware 17504 may be implemented in a standalone network node with generic or specific components. Hardware 17504 may implement some functions via virtualization. Alternatively, hardware 17504 may be part of a larger cluster of hardware (e.g. such as in a data center or CPE) where many hardware nodes work together and are managed via management and orchestration 17510, which, among others, oversees lifecycle management of applications 17502. In some embodiments, hardware 17504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 17512 which may alternatively be used for communication between hardware nodes and radio units.

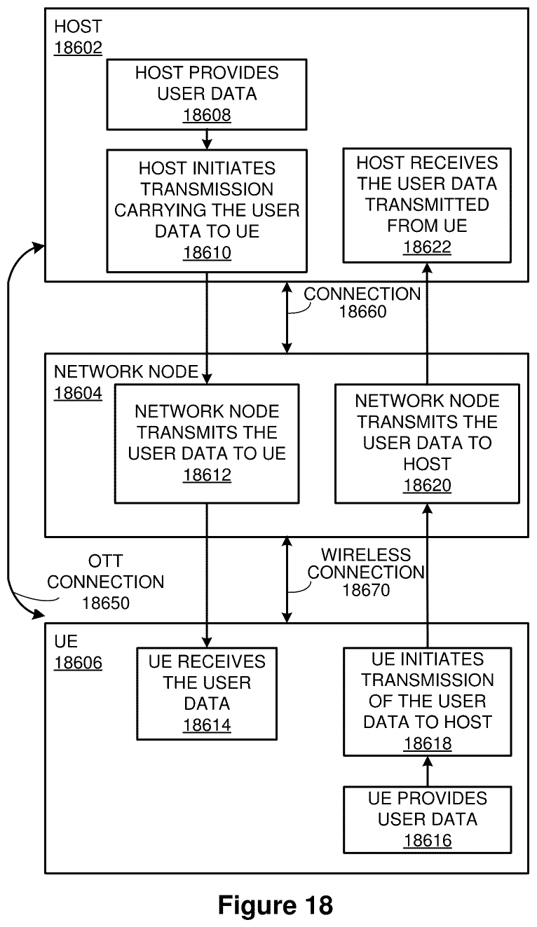

FIG. 18 shows a communication diagram of a host 18602 communicating via a network node 18604 with a UE 18606 over a partially wireless connection in accordance with some embodiments. Example implementations, in accordance with various embodiments, of the UE (such as a UE 13112a of FIG. 13 and/or UE 14200 of FIG. 14), network node (such as network node 13110a of FIG. 13 and/or network node 15300 of FIG. 15), and host (such as host 13116 of FIG. 13 and/or host 16400 of FIG. 16) discussed in the preceding paragraphs will now be described with reference to FIG. 18.

Like host 16400, embodiments of host 18602 include hardware, such as a communication interface, processing circuitry, and memory. The host 18602 also includes software, which is stored in or accessible by the host 18602 and executable by the processing circuitry. The software includes a host application that may be operable to provide a service to a remote user, such as the UE 18606 connecting via an over-the-top (OTT) connection 18650 extending between the UE 18606 and host 18602. In providing the service to the remote user, a host application may provide user data which is transmitted using the OTT connection 18650.

The network node 18604 includes hardware enabling it to communicate with the host 18602 and UE 18606. The connection 18660 may be direct or pass through a core network (like core network 13106 of FIG. 13) and/or one or more other intermediate networks, such as one or more public, private, or hosted networks. For example, an intermediate network may be a backbone network or the Internet.

The UE 18606 includes hardware and software, which is stored in or accessible by UE 18606 and executable by the UE's processing circuitry. The software includes a client application, such as a web browser or operator-specific “app” that may be operable to provide a service to a human or non-human user via UE 18606 with the support of the host 18602. In the host 18602, an executing host application may communicate with the executing client application via the OTT connection 18650 terminating at the UE 18606 and host 18602. In providing the service to the user, the UE's client application may receive request data from the host's host application and provide user data in response to the request data. The OTT connection 18650 may transfer both the request data and the user data. The UE's client application may interact with the user to generate the user data that it provides to the host application through the OTT connection 18650.

The OTT connection 18650 may extend via a connection 18660 between the host 18602 and the network node 18604 and via a wireless connection 18670 between the network node 18604 and the UE 18606 to provide the connection between the host 18602 and the UE 18606. The connection 18660 and wireless connection 18670, over which the OTT connection 18650 may be provided, have been drawn abstractly to illustrate the communication between the host 18602 and the UE 18606 via the network node 18604, without explicit reference to any intermediary devices and the precise routing of messages via these devices.

As an example of transmitting data via the OTT connection 18650, in step 18608, the host 18602 provides user data, which may be performed by executing a host application. In some embodiments, the user data is associated with a particular human user interacting with the UE 18606. In other embodiments, the user data is associated with a UE 18606 that shares data with the host 18602 without explicit human interaction. In step 18610, the host 18602 initiates a transmission carrying the user data towards the UE 18606. The host 18602 may initiate the transmission responsive to a request transmitted by the UE 18606. The request may be caused by human interaction with the UE 18606 or by operation of the client application executing on the UE 18606. The transmission may pass via the network node 18604, in accordance with the teachings of the embodiments described throughout this disclosure. Accordingly, in step 18612, the network node 18604 transmits to the UE 18606 the user data that was carried in the transmission that the host 18602 initiated, in accordance with the teachings of the embodiments described throughout this disclosure. In step 18614, the UE 18606 receives the user data carried in the transmission, which may be performed by a client application executed on the UE 18606 associated with the host application executed by the host 18602.

In some examples, the UE 18606 executes a client application which provides user data to the host 18602. The user data may be provided in reaction or response to the data received from the host 18602. Accordingly, in step 18616, the UE 18606 may provide user data, which may be performed by executing the client application. In providing the user data, the client application may further consider user input received from the user via an input/output interface of the UE 18606. Regardless of the specific manner in which the user data was provided, the UE 18606 initiates, in step 18618, transmission of the user data towards the host 18602 via the network node 18604. In step 18620, in accordance with the teachings of the embodiments described throughout this disclosure, the network node 18604 receives user data from the UE 18606 and initiates transmission of the received user data towards the host 18602. In step 18622, the host 18602 receives the user data carried in the transmission initiated by the UE 18606.

One or more of the various embodiments improve the performance of OTT services provided to the UE 18606 using the OTT connection 18650, in which the wireless connection 18670 forms the last segment. More precisely, the teachings of these embodiments may improve the allocation of resources and thereby provide benefits such as decreased network interference and/or reallocation of unused resources and increased system performance.

In an example scenario, factory status information may be collected and analyzed by the host 18602. As another example, the host 18602 may process audio and video data which may have been retrieved from a UE for use in creating maps. As another example, the host 18602 may collect and analyze real-time data to assist in controlling vehicle congestion (e.g., controlling traffic lights). As another example, the host 18602 may store surveillance video uploaded by a UE. As another example, the host 18602 may store or control access to media content such as video, audio, VR or AR which it can broadcast, multicast or unicast to UEs. As other examples, the host 18602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 18650 between the host 18602 and UE 18606, in response to variations in the measurement results. The measurement procedure and/or the network functionality for reconfiguring the OTT connection may be implemented in software and hardware of the host 18602 and/or UE 18606. In some embodiments, sensors (not shown) may be deployed in or in association with other devices through which the OTT connection 18650 passes; the sensors may participate in the measurement procedure by supplying values of the monitored quantities exemplified above, or supplying values of other physical quantities from which software may compute or estimate the monitored quantities. The reconfiguring of the OTT connection 18650 may include message format, retransmission settings, preferred routing etc.; the reconfiguring need not directly alter the operation of the network node 18604. Such procedures and functionalities may be known and practiced in the art. In certain embodiments, measurements may involve proprietary UE signaling that facilitates measurements of throughput, propagation times, latency and the like, by the host 18602. The measurements may be implemented in that software causes messages to be transmitted, in particular empty or ‘dummy’ messages, using the OTT connection 18650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

A listing of embodiments is provided below:
1. A method performed by a first network node (13110/15300, 13112/14200, 13112A) in a communication system, the method comprising:
transmitting (1103) an indicator comprising one of (i) a first indicator comprising an indication that one or more resources is unutilized in a periodic multi-slot allocation for a second network node within a period, or (ii) a second indicator comprising an indication of a shortage of one or more resources in the periodic multi-slot allocation for the second network node within the period; and
performing (1105) one of (i) responsive to transmitting or receiving the first indicator, reducing the periodic multi-slot allocation by at least part of the unutilized one or more resources for at least a period, or (ii) responsive to transmitting or receiving the second indicator, adding at least one resource to at least a period.
2. The method of Embodiment 1, wherein the first network node and the second network node, respectively, comprise one of a gNodeB, an eNodeB, and a user equipment, UE.
3. The method of Embodiment 2, wherein when the first network node comprises a gNodeB or an eNodeB, the periodic multi-slot allocation comprises a periodic multi-slot physical downlink shared channel, PDSCH, semi-persistent scheduling, SPS.
4. The method of Embodiment 2, wherein when the second network node comprises a UE, the periodic multi-slot allocation comprises a periodic multi-slot physical uplink shared channel, PUSCH, configured grant, CG.
5. The method of any one of Embodiments 1 to 4, wherein the one or more resources comprise one or more transport blocks, TBs, or one or more hybrid automatic repeat request, HARQ, processes.
6. The method of any one of Embodiments 1 to 5, wherein the indicator comprises one of an explicit indicator, and an implicit indicator from which a receiver of the second network node can derive the indicator from a policy.
7. The method of any one of Embodiments 1 to 6, wherein the first indicator further comprises information indicating at least one of (i) a number of periods for which the reducing applies, and (ii) a pattern of periods for which the reducing applies.
8. The method of any one of Embodiments 1 to 7, further comprising:
transmitting (1107) information indicating a size change of the periodic multi-slot allocation, wherein the size change comprises one of (i) a reduction in a size of the periodic multi-slot allocation in at least a period, (ii) an increase in a size of the periodic multi-slot allocation in at least a period, or (iii) a combination of a reduction and an increase in a size of the periodic multi-slot allocation in at least a period.
9. The method of Embodiment 8, wherein the information is transmitted in one of the indicator or in control signaling.
10. The method of Embodiment 9, wherein the control signaling indicates the one or more resources that are unutilized and/or the one or more resources that have a shortage within at least the period.
11. The method of Embodiment 9, wherein the control signaling indicates a number of hybrid automatic repeat request, HARQ, processes, a number of transport blocks, or a number of occasions within at least the period that will be unutilized for data transmission.
12. The method of Embodiment 9, wherein the information transmitted in at least the period applies to a later period of the periodic multi-slot allocation.
13. The method of Embodiment 9, wherein the information transmitted in at least the period applies to a specified duration of a later period of the periodic multi-slot allocation.
14. The method of any one of Embodiments 9 to 13, wherein the indicator or the control signaling is applicable for (i) a plurality of configured grants when the first network node network node comprises a user equipment, or (ii) a plurality of semi-persistent scheduling, SPS, periodic multi-slot allocations when the first network node comprises a gNodeB or an eNodeB.
15. The method of any one of Embodiments 8 to 14, wherein the one or more resources comprise one or more transport blocks, TBs, or one or more hybrid automatic repeat request, HARQ, process, and the indicator is transmitted in at least one of (i) a first occasion of a first TB or a first HARQ process in the periodic multi-slot allocation, (ii) all occasions of TBs or HARQ processes in the periodic multi-slot allocation, and (iii) at least a time interval before a TB or a HARQ process that enables decoding of the indicator.
16. The method of any one of Embodiments 8 to 15, wherein the indicator further comprises an indication of a configuration that determines the one or more resources that are unutilized or have a shortage in at least the period.
17. The method of any one of Embodiment 8 to 16, further comprising:
receiving (1101) activation signaling of (i) a semi-persistent scheduling, SPS, periodic multi-slot allocation when the first network node comprises a gNodeB or an eNodeB, or (ii) a configured grant when the first network node comprises a user equipment, UE,
wherein the activation signaling indicates whether the indicator is enabled or not enabled and, when enabled, the activation signaling further indicates the periodic multi-slot allocation, and rules for the indicator.
18. The method of any one of Embodiments 8 to 17, wherein the indicator is multiplexed with other information comprising control information.
19. The method of any one of Embodiments 8 to 18, wherein the indicator further indicates a probability value for the one or more resources remaining unutilized for future periods.
20. The method of any one of Embodiments 1 to 19, further comprising:
responsive to transmitting the first indicator, scheduling (1109) the second network node or another entity in the communication system to use the unutilized one or more resources from at least the period.
21. The method of Embodiment 20, wherein the scheduling occurs responsive to the first network node freeing the unutilized one or more resources before a modification to add one or more resources occurs.
22. The method of any one of Embodiments 20 to 21, wherein the scheduling occurs responsive to a timing signal.
23. The method of any one of Embodiments 20 to 22, wherein the scheduling occurs based on a time interval associated with a quality of service, QoS, transmitted by the first network node.
24. The method of any one of Embodiments 20 to 23, wherein the scheduling occurs based on a modification request that is approved by the first network node.
25. The method of any one of Embodiments 1 to 24, further comprising:
transmitting (1111) a modulation coding scheme, MCS, that indicates that additional bits per a resource in the periodic multi-slot allocation can be packed; and
releasing (1113) one or more of the resources based on the second network node being able to pack more bits per the resource.
26. The method of Embodiment 25, wherein the indicator further indicates the MCS in a period.
27. The method of any one of Embodiments 25 to 26, wherein a size of a physical resource block, PRB, of the periodic multi-slot allocation remains the same and the indicator further indicates a change in the MCS.
28. The method of any one of the Embodiments 25 to 27, wherein the indicator is encoded and/or decoded independently of encoding and/or decoding of the one or more resources.
29. The method of any one of Embodiments 25 to 28, wherein the first network node selects the MCS from a range of MCS and includes the selected MCS in the indicator.
30. The method of any one of Embodiments 1 to 29, wherein the adding the one or more resource comprises adding one or more transport blocks, TBs, to the periodic multi-slot allocation in at least the period.
31. The method of Embodiment 30, wherein the second indicator further comprises information indicating at least one of (i) an identity of one or more periods in which to add the one or more TBs, (ii) where to add the one or more TBS in one or more periods, and (ii) a pattern of periods for which the adding applies.
32. The method of any one of Embodiments 1 to 32, wherein the performing the reducing and/or the performing the adding is performed in a recurring periodic multi-slot allocation pattern.
33. A method performed by a second network node (13112/14200, 13110/15300, 13112B) in a communication system, the method comprising:
receiving (1203) an indicator from a first network node comprising one of (i) a first indicator comprising an indication that one or more resources is unutilized in a periodic multi-slot allocation for the second network node within a period, or (ii) a second indicator comprising an indication of a shortage of one or more resources in the periodic multi-slot allocation for the second network node within the period; and
responsive to receiving the first indicator, omitting (1205) to monitor or decode a transmission from the first network node over the one or more unutilized resources in the period.
34. The method of Embodiment 33, further comprising:
indicating (1201) to the first network node the shortage of one or more resources in the periodic multi-slot allocation.
35. The method of Embodiment 34, wherein the indicating is included in at least one of a buffer status report, BSR, an uplink control information, UCI, and a scheduling request, SR.
36. The method of any one of Embodiments 33 to 35, wherein the first and the second network node, respectively, comprise one of a user equipment, UE, a gNodeB, and an eNodeB.
37. The method of Embodiment 36, wherein when the first network node comprises a gNodeB or an eNodeB, the periodic multi-slot allocation comprises a periodic multi-slot physical downlink shared channel, PDSCH, semi-persistent scheduling, SPS.
38. The method of Embodiment 36, wherein when the second network node comprises a UE, the periodic multi-slot allocation comprises a periodic multi-slot physical uplink shared channel, PUSCH, configured grant, CG.
39. The method of any one of Embodiments 33 to 38, wherein the one or more resources comprise one or more transport blocks, TBs, or one or more hybrid automatic repeat request, HARQ, processes.
40. The method of any one of Embodiments 33 to 39, wherein the indicator comprises one of an explicit indicator, and an implicit indicator from which a receiver of the second network node can derive the indicator from a policy.
41. The method of any one of Embodiments 33 to 40, wherein the first indicator further comprises information indicating at least one of (i) a number of periods for which the reducing applies, and (ii) a pattern of periods for which the reducing applies.
42. The method of any one of Embodiments 33 to 41, further comprising:
receiving (1207) information indicating a size change of the periodic multi-slot allocation, wherein the size change comprises one of (i) a reduction in a size of the periodic multi-slot allocation in at least a period, (ii) an increase in a size of the periodic multi-slot allocation in at least a period, or (iii) a combination of a reduction and an increase in a size of the periodic multi-slot allocation in at least a period.
43. The method of Embodiment 42, wherein the information is received in one of the indicator or in control signaling.
44. The method of Embodiment 43, wherein the control signaling indicates the one or more resources that are unutilized and/or the one or more resources that have a shortage within at least the period.
45. The method of Embodiment 43, wherein the control signaling indicates a number of hybrid automatic repeat request, HARQ, processes, a number of transport blocks, or a number of occasions within at least the period that will be unutilized for data transmission.
46. The method of any one of Embodiments 42 to 45, wherein the information transmitted in at least the period applies to a later period of the periodic multi-slot allocation.
47. The method of any one of Embodiments 42 to 45, wherein the information transmitted in at least the period applies to a specified duration of a later period of the periodic multi-slot allocation.
48. The method of any one of Embodiments 43 to 47, wherein the indicator or the control signaling is applicable for (i) a plurality of configured grants when the second network node comprises a user equipment, or (ii) a plurality of semi-persistent scheduling, SPS, periodic multi-slot allocations when the first network node comprises a gNodeB or an eNodeB.
49. The method of any one of Embodiments 42 to 48, wherein the one or more resources comprise one or more transport blocks, TBs, or one or more hybrid automatic repeat request, HARQ, process, and the indicator is transmitted in at least one of (i) a first occasion of a first TB or a first HARQ process in the periodic multi-slot allocation, (ii) all occasions of TBs or HARQ processes in the periodic multi-slot allocation, and (iii) at least a time interval before a TB or a HARQ process that enables decoding of the indicator.
50. The method of any one of Embodiments 42 to 49, wherein the indicator further comprises an indication of a configuration that determines the one or more resources that are unutilized or have a shortage in at least the period.
51. The method of any one of Embodiments 42 to 50, wherein the indicator is multiplexed with other information comprising control information.
52. The method of any one of Embodiments 42 to 51, wherein the indicator further indicates a probability value for the one or more resources remaining unutilized for future periods.
53. The method of any one of Embodiments 33 to 52, further comprising:
receiving (1209) a schedule to use the unutilized one or more resources from at least the period.
54. The method of Embodiment 53, wherein the schedule occurs responsive to the first network node freeing the unutilized one or more resources before a modification to add one or more resources occurs.
55. The method of any one of Embodiments 53 to 54, wherein the schedule occurs responsive to a timing signal.
56. The method of any one of Embodiments 53 to 55, wherein the schedule occurs based on a time interval associated with a quality of service, Qos, transmitted by the first network node.
57. The method of any one of Embodiments 53 to 56, wherein the schedule occurs based on a modification request that is approved by the first network node.
58. The method of any one of Embodiments 33 to 57, further comprising:
receiving (1211) a modulation coding scheme, MCS, that indicates that additional bits per a resource in the periodic multi-slot allocation can be packed; and
receiving (1213) a release one or more of the resources based on the second network node being able to pack more bits per the resource.
59. The method of Embodiment 58, wherein the indicator further indicates the MCS in a period.
60. The method of any one of Embodiments 57 to 59, wherein a size of a physical resource block, PRB, of the periodic multi-slot allocation remains the same and the indicator further indicates a change in the MCS.
61. The method of any one of the Embodiments 57 to 60, wherein the indicator is encoded and/or decoded independently of encoding and/or decoding of the one or more resources.
62. The method of any one of Embodiments 57 to 61, wherein the first network node selects the MCS from a range of MCS and includes the selected MCS in the indicator.
63. The method of any one of Embodiments 33 to 62, wherein the adding the one or more resource comprises adding one or more transport blocks, TBs, to the periodic multi-slot allocation in at least the period.
64. The method of Embodiment 63, wherein the second indicator further comprises information indicating at least one of (i) an identity of one or more periods in which to add the one or more TBs, (ii) where to add the one or more TBS in one or more periods, and (ii) a pattern of periods for which the adding applies.
65. The method of any one of Embodiments 33 to 64, wherein the performing the reducing and/or the performing the adding is performed in a recurring periodic multi-slot allocation pattern.
66. A first network node (13110/15300, 13112/14200) in a communication system, the first network node comprising:
processing circuitry (15302, 14202);
memory (15304, 14210) coupled with the processing circuitry, wherein the memory includes instructions that when executed by the processing circuitry causes the first network node to perform operations comprising:
transmit an indicator comprising one of (i) a first indicator comprising an indication that one or more resources is unutilized in a periodic multi-slot allocation for a second network node within a period, or (ii) a second indicator comprising an indication of a shortage of one or more resources in the periodic multi-slot allocation for the second network node within the period; and
perform one of (i) responsive to transmitting or receiving the first indicator, reducing the periodic multi-slot allocation by at least part of the unutilized one or more resources for at least a period, or (ii) responsive to transmitting or receiving the second indicator, adding at least one resource to at least a period.
67. The network node of Embodiment 66, wherein the memory includes instructions that when executed by the processing circuitry causes the first network node to perform further operations comprising any of the operations of any one of Embodiments 2 to 32.
68. A first network node (13110/15300, 13112/14200, 13112A) in a communication system, the first network node adapted to perform operations comprising:
transmit an indicator comprising one of (i) a first indicator comprising an indication that one or more resources is unutilized in a periodic multi-slot allocation for a second network node within a period, or (ii) a second indicator comprising an indication of a shortage of one or more resources in the periodic multi-slot allocation for the second network node within the period; and
perform one of (i) responsive to transmitting or receiving the first indicator, reducing the periodic multi-slot allocation by at least a part of the unutilized one or more resources for at least a period, or (ii) responsive to transmitting or receiving the second indicator, adding at least one resource to at least a period.
69. The network node of Embodiment 68 adapted to perform further operations according to any one of Embodiments 2 to 32.
70. A computer program comprising program code to be executed by processing circuitry (15302, 14202) of a first network node (13110/15300, 13112/14200, 13112A) in a communication system, whereby execution of the program code causes the first network node to perform operations comprising:
transmit an indicator comprising one of (i) a first indicator comprising an indication that one or more resources is unutilized in a periodic multi-slot allocation for a second network node within a period, or (ii) a second indicator comprising an indication of a shortage of one or more resources in the periodic multi-slot allocation for the second network node within the period; and
perform one of (i) responsive to transmitting or receiving the first indicator, reducing the periodic multi-slot allocation by at least a part of the unutilized one or more resources for at least a period, or (ii) responsive to transmitting or receiving the second indicator, adding at least one resource to at least a period.
71. The computer program of Embodiment 70, whereby execution of the program code causes the first network node to perform operations according to any one of Embodiments 2 to 32.
72. A computer program product comprising a non-transitory storage medium (15304, 14210) including program code to be executed by processing circuitry (15302, 14202) of a first network node (13110/15300, 13112/14200, 13112A) in a communication system, whereby execution of the program code causes the first network node to perform operations comprising:
transmit an indicator comprising one of (i) a first indicator comprising an indication that one or more resources is unutilized in a periodic multi-slot allocation for a second network node within a period, or (ii) a second indicator comprising an indication of a shortage of one or more resources in the periodic multi-slot allocation for the second network node within the period; and
perform one of (i) responsive to transmitting or receiving the first indicator, reducing the periodic multi-slot allocation by at least a part of the unutilized one or more resources for at least a period, or (ii) responsive to transmitting or receiving the second indicator, adding at least one resource to at least a period.
73. The computer program product of Embodiment 72, whereby execution of the program code causes the first network node to perform operations according to any one of Embodiments 2 to 32.
74. A second network node (13112/14200, 13110/15300, 13112B) in a communication system, the second network node comprising:
processing circuitry (14202, 15302);
memory (14210, 15304) coupled with the processing circuitry, wherein the memory includes instructions that when executed by the processing circuitry causes the first network node to perform operations comprising:
receive an indicator from a first network node comprising one of (i) a first indicator comprising an indication that one or more resources is unutilized in a periodic multi-slot allocation for the second network node within a period, or (ii) a second indicator comprising an indication of a shortage of one or more resources in the periodic multi-slot allocation for the second network node within the period; and
responsive to receiving the first indicator, omit to monitor or decode a transmission from the first network node over the one or more unutilized resources in the period.
75. The network node of Embodiment 74, wherein the memory includes instructions that when executed by the processing circuitry causes the second network node to perform further operations comprising any of the operations of any one of Embodiments 34 to 65.
76. A second network node (13112/14200, 13110/15300, 13112B) in a communication system, the second network node adapted to perform operations comprising:
receive an indicator from a first network node comprising one of (i) a first indicator comprising an indication that one or more resources is unutilized in a periodic multi-slot allocation for the second network node within a period, or (ii) a second indicator comprising an indication of a shortage of one or more resources in the periodic multi-slot allocation for the second network node within the period; and
responsive to receiving the first indicator, omit to monitor or decode a transmission from the first network node over the one or more unutilized resources in the period.
77. The network node of Embodiment 76 adapted to perform further operations according to any one of Embodiments 34 to 65.
78. A computer program comprising program code to be executed by processing circuitry (14202, 15302) of a second network node (13112/14200, 13110/15300, 13112B) in a communication system, whereby execution of the program code causes the second network node to perform operations comprising:
receive an indicator from a first network node comprising one of (i) a first indicator comprising an indication that one or more resources is unutilized in a periodic multi-slot allocation for the second network node within a period, or (ii) a second indicator comprising an indication of a shortage of one or more resources in the periodic multi-slot allocation for the second network node within the period; and
responsive to receiving the first indicator, omit to monitor or decode a transmission from the first network node over the one or more unutilized resources in the period.
79. The computer program of Embodiment 78, whereby execution of the program code causes the second network node to perform operations according to any one of Embodiments 34 to 65.
80. A computer program product comprising a non-transitory storage medium (14210, 15304) including program code to be executed by processing circuitry (14202, 15302) of a second network node (13112/14200, 13110/15300, 13112B) in a communication system, whereby execution of the program code causes the second network node to perform operations comprising:
receive an indicator from a first network node comprising one of (i) a first indicator comprising an indication that one or more resources is unutilized in a periodic multi-slot allocation for the second network node within a period, or (ii) a second indicator comprising an indication of a shortage of one or more resources in the periodic multi-slot allocation for the second network node within the period; and
responsive to receiving the first indicator, omit to monitor or decode a transmission from the first network node over the one or more unutilized resources in the period.
81. The computer program product of Embodiment 80, whereby execution of the program code causes the second network node to perform operations according to any one of Embodiments 34 to 65.

1. A method performed by a first network node in a communication system, the method comprising:
transmitting an indicator comprising one of
a first indicator comprising an indication that shows which of one or more resources is unutilized in a configured periodic resource allocation, or
a second indicator comprising an indication of a shortage of one or more resources in the configured periodic resource allocation; and
performing one of
if transmitting the first indicator, not transmitting on the unutilized resources, or
if transmitting the second indicator, adding at least one resource.

2. The method of claim 1, wherein the configured periodic resource allocation comprises a periodic multi slot physical uplink shared channel, PUSCH, allocation, a periodic single-slot PUSCH allocation, or a multi-PUSCH configured grant.

3. The method of claim 1, wherein the one or more resources comprise one or more transport blocks, TBs, or, the one or more resources is one or more PUSCH.

4. The method of claim 1, wherein the first indicator or the second indicator comprises one of an explicit indicator, and an implicit indicator from which a receiver of a second network node can derive the indicator from a policy.

5. The method of claim 1, wherein the first indicator further comprises information indicating at least one of
a number of periods for which the one or more resources is unutilized and
a pattern of periods for which the one or more resources is unutilized.

6. The method of claim 1, wherein at least one of the first indicator and the second indicator comprises information indicating a size change of the configured periodic resource allocation, wherein the size change comprises one of
a reduction in a size of the configured periodic resource allocation,
an increase in a size of the configured periodic resource allocation, or
a combination of a reduction and an increase in a size of the configured periodic resource allocation.

7. The method of claim 1, wherein the first indicator or the second indicator is transmitted in control signaling, wherein the control signaling indicates a number of occasions within at least a period that will be unutilized for data transmission.

8. (canceled)

9. The method of claim 1, wherein the first indicator or the second indicator is applicable for a plurality of configured grants.

10. The method of claim 1, wherein the one or more resources comprise one or more transport blocks, TBs, and the first indicator or the second indicator is transmitted in at least one of
a first occasion of a first TB in the configured periodic resource allocation,
all occasions of TBs in the configured periodic resource allocation, and
at least a time interval before a TB that enables decoding of the first indicator or the second indicator.

11. The method of claim 1, wherein the first indicator or the second indicator further comprises an indication of a configuration that determines the one or more resources that are unutilized or have a shortage.

12. The method of claim 1, wherein the first indicator or the second indicator is transmitted in a period of the configured periodic resource allocation and applies to a later period of the configured periodic resource allocation.

13. The method of claim 1, wherein the first indicator or the second indicator is transmitted in a resource of the configured periodic resource allocation.

14. The method of claim 1, wherein the first indicator or the second indicator is transmitted in a buffer status report, BSR.

15. The method of claim 1, wherein the first indicator or the second indicator is transmitted in a period of the configured periodic resource allocation and applies to a specified duration of a later period of the configured periodic resource allocation.

16. The method of claim 1, wherein the first indicator or the second indicator comprises at least one of
a number of consecutive transmission occasions, TOs, in the configured periodic resource allocation that are unutilized,
a time duration or a time range of a TO in the configured periodic resource allocation that is unutilized, and
a number of non-consecutive TOs in the configured periodic resource allocation that are unutilized.

17. The method of claim 1, further comprising:
receiving activation signaling a configured grant, wherein the activation signaling indicates whether the first indicator or the second indicator is enabled or not enabled and, when enabled, the activation signaling further indicates the configured periodic resource allocation, and rules for the first indicator or the second indicator.

18. (canceled)

19. The method of claim 1, wherein the first indicator or the second indicator further indicates a probability value for the one or more resources remaining unutilized for a future period.

20. The method of claim 1, wherein the configured periodic resource allocation is allocated in a radio resource control, RRC, signal.

21. The method of claim 1, wherein the first indicator or the second indicator comprises uplink control information, UCI.

22. The method of claim 1, wherein transmitting the first indicator or the second indicator comprises transmitting the first indicator or the second indicator over control signaling that is multiplexed or included in a PUSCH.

23. The method of claim 21, wherein the UCI comprises a configured grant-UCI.

24. The method of claim 21, wherein the UCI is included in a configured grant PUSCH.

25. The method of claim 1, wherein when the first network node comprises a user equipment, UE.

26. A first network node comprising:
processing circuitry;
memory coupled with the processing circuitry, wherein the memory includes instructions that when executed by the processing circuitry causes the first network node to perform operations comprising:
transmit an indicator comprising one of
a first indicator comprising an indication that shows which of one or more resources is unutilized in a configured periodic resource allocation, or
a second indicator comprising an indication of a shortage of one or more resources in the configured periodic resource allocation; and
perform one of
if transmitting the first indicator, not transmitting on the unutilized resources, or
if transmitting the second indicator, adding at least one resource.

27-33. (canceled)
